(19) United States
(12) Patent Application Publication
(10) Pub. No.: US 2015/0245049 A1
(43) Pub. Date: Aug. 27, 2015

(54) IMAGE PROCESSING METHOD AND APPARATUS FOR PREDICTING MOTION VECTOR AND DISPARITY VECTOR

(71) Applicant: SAMSUNG ELECTRONICS CO., LTD., Suwon-si Gyeonggi-do (KR)

(72) Inventors: Jin Young Lee, Yongin-si (KR); Jae Joon Lee, Yongin-si (KR)

(73) Assignee: SAMSUNG ELECTRONICS CO., LTD., Suwon-si, Gyeonggi-do (KR)

(21) Appl. No.: 14/432,410

(22) PCT Filed: Sep. 25, 2013
(86) PCT No.: PCT/KR2013/008563

§ 371 Date: Mar. 30, 2015

Related U.S. Application Data
(60) Provisional application No. 61/707,524, filed on Sep. 28, 2012.
(60) Provisional application No. 61/746,272, filed on Dec. 27, 2012.

(30) Foreign Application Priority Data
Sep. 24, 2013 (KR) 10-2013-0112962

(51) Int. Cl. H04N 19/52; H04N 19/597; H04N 19/615; H04N 19/182; H04N 19/176

(52) U.S. Cl. CPC H04N 19/52; H04N 19/182; H04N 19/176; H04N 19/615; H04N 19/597

(57) ABSTRACT

An image processing method and an apparatus for predicting a motion vector and a disparity vector. The image processing method according to an embodiment may determine a disparity vector of a current block, which is included in a color image, by using a depth image corresponding to the color image. A three-dimensional (3D) video may be efficiently compressed by predicting the motion vector or the disparity vector by using the depth image.

### CROSS-REFERENCE TO RELATED APPLICATIONS

This application is a U.S. National Phase application of International Application No. PCT/KR2013/008563, filed Sep. 25, 2013, which claims the priority benefit of U.S. Provisional Application No. 61/707,524, filed Sep. 28, 2012 in the U.S. Patent and Trademark Office and U.S. Provisional Application No. 61/746,272, filed Dec. 27, 2012 in the U.S. Patent and Trademark Office, and claims foreign priority benefit of Korean Application No. 10-2013-0112962, filed Sep. 24, 2013, in the Korean Intellectual Property Office, the disclosures of each of which are incorporated herein by reference.

### BACKGROUND

1. Field

The following description relates to an efficient compression and decompression of a three-dimensional (3D) video, and more particularly, to an image processing method and apparatus for efficiently estimating a motion vector and a disparity vector.

2. Description of the Related Art

A stereoscopic image refers to a three-dimensional (3D) image that simultaneously provides shape information about a depth and a space together with image information. Different from a stereo image that simply provides images of different views to left and right eyes of a user, respectively, the stereoscopic image is seen as if viewed from different directions as the user varies the user's point of view. Therefore, images taken from many different views are used to create the stereoscopic image.

Since the images taken from different views to create the stereoscopic image have a great amount of data, it is almost impracticable to compress the images using an encoding apparatus optimized for a single-view video coding, such as MPEG-2, H.264.AVC, and HEVC, in consideration of a network infrastructure, a terrestrial bandwidth, and the like.

Accordingly, there is a need for a multi-view image encoding apparatus optimized for creating a stereoscopic image. In particular, a technology for efficiently reducing a redundancy between a time and a view is desired.

### SUMMARY

Additional aspects and/or advantages will be set forth in part in the description which follows and, in part, will be apparent from the description, or may be learned by practice of the invention.

An image processing method according to an embodiment may include identifying a depth image corresponding to a current block of a color image; and determining a disparity vector of the current block based on a depth value of a pixel included in the depth image.

An image processing method according to an embodiment may include identifying a disparity vector of at least one neighbor block adjacent to a current block of a color image; determining a disparity vector of the neighbor block using a depth image corresponding to the color image when the neighbor block does not have a disparity vector; and determining a disparity vector of the current block based on the disparity vector of the least one neighbor block.

An image processing method according to an embodiment may include determining a disparity vector of a current block of a color image using a disparity vector of at least one neighbor block adjacent to the current block of the color image; and determining a motion vector of the current block using the determined disparity vector of the current block.

An image processing method according to an embodiment may include identifying a motion vector of at least one neighbor block adjacent to a current block of a color image; determining a motion vector of the neighbor block using a depth image corresponding to the color image when the neighbor block does not have a motion vector; and determining a motion vector of the current block based on the motion vector of the at least one neighbor block.

An image processing apparatus according to an embodiment may include a depth image identifier configured to identify a depth image corresponding to a current block of a color image; and a disparity vector determiner configured to determine a disparity vector of the current block based on a depth value of a pixel included in the depth image.

An image processing apparatus according to an embodiment may include a disparity vector extractor configured to extract a disparity vector of at least one neighbor block adjacent to a current block of a color image; and a disparity vector determiner configured to determine a disparity vector of the current block based on the disparity vector of the at least one neighbor block.

An image processing apparatus according to an embodiment may include a disparity vector determiner configured to determine a disparity vector of a current block of a color image using a disparity vector of at least one neighbor block adjacent to the current block of the color image; and a motion vector determiner configured to determine a motion vector of the current block using the determined disparity vector of the current block.

An image processing apparatus according to an embodiment may include a motion vector extractor configured to extract a motion vector of at least one neighbor block adjacent to a current block of a color image; and a motion vector determiner configured to determine a motion vector of the current block based on the motion vector of the at least one neighbor block.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a block diagram to describe an operation of an encoding apparatus and a decoding apparatus according to an example embodiment.

FIG. 2 is a block diagram illustrating an image processing apparatus for predicting a disparity vector of a current block according to an example embodiment.

FIG. 3 is a block diagram illustrating an image processing apparatus for predicting a motion vector of a current block according to an example embodiment.

FIG. 4 is a block diagram illustrating an image processing apparatus for predicting a motion vector of a current block according to another example embodiment.

FIG. 5 is a block diagram illustrating an image processing apparatus for predicting a motion vector of a current block according to still another example embodiment.

FIG. 6 illustrates a structure of a multi-view video according to an embodiment.

FIG. 7 illustrates a reference image used when coding a current block according to an example embodiment.

FIG. 8 is a diagram to describe an operation of an encoding apparatus according to an example embodiment.

FIG. 9 is a diagram to describe an operation of a decoding apparatus according to an example embodiment.

FIG. 10 is a diagram including a flowchart illustrating a process of predicting a disparity vector of a current block according to an example embodiment.

FIG. 11 is a diagram including a flowchart illustrating a process of predicting a motion vector of a current block with respect to a skip mode and a direct mode according to an example embodiment.

FIG. 12 is a diagram illustrating a process of predicting a motion vector of a current block using a disparity vector according to an example embodiment.

FIG. 13 is a diagram including a flowchart illustrating a process of predicting a motion vector of a current block with respect to an inter-mode according to an example embodiment.

FIG. 14 is a flowchart illustrating an image processing method for predicting a disparity vector of a current block according to an example embodiment.

FIG. 15 is a flowchart illustrating an image processing method for predicting a motion vector of a current block according to an example embodiment.

FIG. 16 is a flowchart illustrating an image processing method for predicting a motion vector of a current block according to another example embodiment.

FIG. 17 is a flowchart illustrating an image processing method for predicting a motion vector of a current block according to still another example embodiment.

### DETAILED DESCRIPTION

Hereinafter, embodiments will be described with reference to the accompanying drawings. The following specific structural and/or functional descriptions are provided to simply describe the embodiments, and thus, it should not be interpreted that the scope of the disclosure is limited to the embodiments described herein. An image processing method according to an embodiment may be performed by an image processing apparatus. Further, like reference numerals of the drawings refer to like constituent elements.

Prior to describing the embodiments, terms disclosed in the embodiments or the claims may be defined as follows:

(1) Current block (Current color block): denotes a block of a color image to be encoded or decoded.

(2) Current color image: denotes a color image including a current block. In detail, a current color image denotes a color image that includes a block to be encoded or decoded.

(3) Depth image corresponding to a current block (corresponding depth image): denotes a depth image corresponding to a color image or a current color image including a current block.

(4) Neighbor block (neighboring block around the current block): denotes encoded or decoded at least one block adjacent to the current block. For example, the neighbor block may be located at an upper end of the current block, a right-upper end of the current block, a left side of the current block, or a left-upper end of the current block.

(5) Corresponding block (co-located depth block in the corresponding depth map): denotes a depth image block included in a depth image corresponding to a current block. For example, the corresponding block may include a block located at the same location as the current block in the depth image corresponding to the color block.

(6) Macroblock (co-located depth macro-block): denotes a depth image block of an upper concept including a corresponding block of a depth image.

(7) Neighbor color image (neighboring color image around the color image including the current color block): denotes a color image having a view different from a view of a color image including a current block. The neighbor color image may be a color image encoded or decoded before an image processing process for the current block is performed.

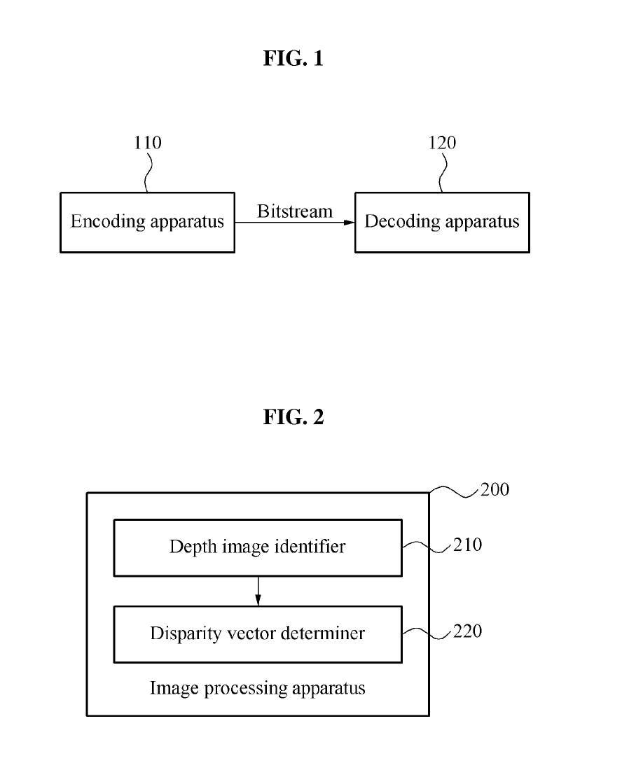

FIG. 1 is a block diagram to describe an operation of an encoding apparatus and a decoding apparatus according to an example embodiment of the present disclosure.

An encoding apparatus 110 according to an embodiment may encode a three-dimensional (3D) video, may create encoded data in a form of a bitstream, and may transmit the created data to a decoding apparatus 120. For example, the 3D video may include color images and depth images taken from many different views. The 3D video has temporal redundancy present between temporally continuous images and inter-view redundancy present between images of different views. The encoding apparatus 110 may efficiently encode the 3D video by effectively removing the temporal redundancy and the inter-view redundancy. Thus, the encoding apparatus 110 may improve the encoding efficiency by maximally removing the redundancy between images during a process of encoding the 3D video.

The encoding apparatus 110 and the decoding apparatus 120 may perform a block-based prediction to remove redundancy between color images. The encoding apparatus 110 and the decoding apparatus 120 may use a depth image to efficiently remove the redundancy between color images. The encoding apparatus 110 and the decoding apparatus 120 may remove the temporal redundancy using a motion vector or a temporal motion vector of a neighbor block. Further, the encoding apparatus 110 and the decoding apparatus 120 may remove the inter-view redundancy using a disparity vector or an inter-view motion vector of the neighbor block and a depth image corresponding to a color image. The encoding apparatus 110 may minimize the redundancy between color images by efficiently encoding a motion vector during a process of encoding a color image of the 3D video.

A size of a depth image corresponding to a color image may differ from a size of the color image. When the size of the depth image differs from the size of the color image, the encoding apparatus 110 and the decoding apparatus 120 may adjust the size of the depth image to be equal to the size of the color image. For example, when the size of the depth image is smaller than the size of the color image, the encoding apparatus 110 and the decoding apparatus 120 may adjust the size of the depth image by up-sampling the depth image, so that the size of the depth image becomes equal to the size of the color image.

However, the present disclosure is not limited to the above-noted example. According to another example embodiment, irrespective of a difference between the size of the depth image and the size of the color image, the original size of the depth image may be used as is. When using the original size of the depth image, a process of sampling the size of the depth image is not required, and thus, a complexity and a required memory amount may decrease.

An image processing apparatus to be described with reference to FIGS. 2 through 17 may be embodied inside or outside the encoding apparatus 110 or the decoding apparatus 120 of FIG. 1.

FIG. 2 is a block diagram illustrating an image processing apparatus for predicting a disparity vector of a current block according to an example embodiment of the present disclosure.

Referring to FIG. 2, an image processing apparatus 200 may include a depth image identifier 210 and a disparity vector determiner 220.

The depth image identifier 210 may identify a depth image corresponding to a current block of a color image. That is, for example, the identifying of the depth image may include determining whether or not a depth image corresponding to the current block of the color image exists. When the depth image corresponding to the color image is absent, the depth image identifier 210 may estimate the depth image corresponding to the current block using neighbor blocks adjacent to the current block, a neighbor color image of the color image including the current block, or another depth image, for example.

The disparity vector determiner 220 may identify a disparity vector of the current block based on depth information of the depth image corresponding to the current block. For example, the disparity vector determiner 220 may identify at least one pixel from among pixels included in the depth image, and may convert the largest depth value among depth values of identified pixels to the disparity vector of the current block.

For example, the disparity vector determiner 220 may determine a disparity vector of a current block based on a depth value of a pixel included in a block of a depth image. The block of the depth image may correspond to the current block. The disparity vector determiner 220 may identify at least one pixel from among pixels included in the block of the depth image that corresponds to the current block. The disparity vector determiner 220 may convert the largest depth value among depth values of identified pixels to a disparity vector, and may determine the converted depth value (i.e., the result of converting the largest depth value to the disparity vector) as the disparity vector of the current block. That is, the disparity vector determiner 220 may convert, to a disparity vector, the largest depth value among depth values of the entire pixels included in the corresponding block of the depth image. Alternatively, the disparity vector determiner 220 may use only a portion of pixels included in the corresponding block of the depth image, and may convert the largest depth value among depth values of the portion of pixels to a disparity vector. According to an example embodiment, the disparity vector determiner 220 may identify pixels located in a predetermined area within the depth image, and may convert the largest depth value among depth values of identified pixels in the predetermined area to the disparity vector of the current block. For example, the disparity vector determiner 220 may identify pixels located at corners of the corresponding block as the predetermined area within the depth image, and may convert the largest depth value among depth values of identified pixels to the disparity vector of the current block. Alternatively, the disparity vector determiner 220 may convert the largest depth value among depth values of pixels located at corners of the corresponding block and a depth value at the center of the corresponding block to the disparity vector of the current block. However, the present disclosure is not limited to the predetermined area being the corners of the corresponding block of the depth image, and thus, the predetermined area may be other areas of the depth image.

In addition, the disparity vector determiner 220 may determine the disparity vector of the current block based on a macroblock including the corresponding block of the depth image. For example, the disparity vector determiner 220 may convert, to a disparity vector, the largest depth value among depth values of pixels included in the macroblock, and may determine the converted disparity vector as the disparity vector of the current block. Alternatively, the disparity vector determiner 220 may convert, to the disparity vector of the current block, the largest depth value among depth values of predetermined pixels included in the macroblock including the corresponding block. For example, the disparity vector determiner 220 may determine the disparity vector of the current block by converting the largest depth value among depth values of pixels located at the corner of the macroblock. The predetermined pixels may be located at other areas of the macroblock, depending on embodiments.

In another example embodiment, the disparity vector determiner 220 may also use only a predetermined pixel within the depth image corresponding to the current color image to determine the disparity vector of the current block. For example, the disparity vector determiner 220 may convert a depth value of a predetermined single pixel included in the depth image, to a disparity vector, and may determine the converted disparity vector as the disparity vector of the current block. Alternatively, the disparity vector determiner 220 may convert a depth value of a predetermined single pixel within the corresponding block or the macroblock to the disparity vector of the current block.

In an inter-view prediction, accurately predicting a moving object is important. In general, the moving object is close to a camera rather than a background, and thus, may have the largest depth value. The disparity vector determiner 220 uses a relationship between the moving object and the depth value to predict the disparity vector of the current block.

During a process of converting a depth value to a disparity vector, the disparity vector determiner 220 may use camera parameter information. The disparity vector determiner 220 may create or generate a disparity vector through a depth value conversion process, and may determine the created disparity vector as the disparity vector of the current block.

According to another embodiment, to determine a disparity vector of a current block of a color image, the disparity vector determiner 220 may use a disparity vector of a neighbor block adjacent to the current block. When the neighbor block adjacent to the current block does not have a disparity vector, the disparity vector determiner 220 may determine the disparity vector of the neighbor block using a depth value of a pixel included in a depth image corresponding to the color image. For example, the disparity vector determiner 220 may convert, to a disparity vector, the largest depth value among depth values of pixels included in a macroblock or a corresponding block of a depth image corresponding to a current block and may determine the converted disparity vector as the disparity vector of the neighbor block. Thus, the disparity vector of the current block may be estimated or determined based on the determined disparity vector of the neighbor block.

Alternatively, the disparity vector determiner 220 may convert, to the disparity vector of the neighbor block, the largest depth value among depth values of predetermined pixels included in the macroblock including the corresponding block. For example, the disparity vector determiner 220 may determine the disparity vector of the neighbor block by converting the largest depth value among depth values of pixels located at corners of the macroblock. To determine the disparity vector of the neighbor block, the disparity vector determiner 220 may also use only a predetermined pixel within a depth image corresponding to a current color image. For example, the disparity vector determiner 220 may convert a depth value of a predetermined single pixel included in the depth image, to a disparity vector, and may determine the converted disparity vector as the disparity vector of the neighbor block.

When the disparity vector of the neighbor block is determined, the disparity vector determiner 220 may determine the disparity vector of the current block using the disparity vector of the neighbor block and a median filter. For example, the disparity vector determiner 220 may apply a median filter to a disparity vector of at least one neighbor block adjacent to the current block and may determine a median filtered result as a current disparity vector.

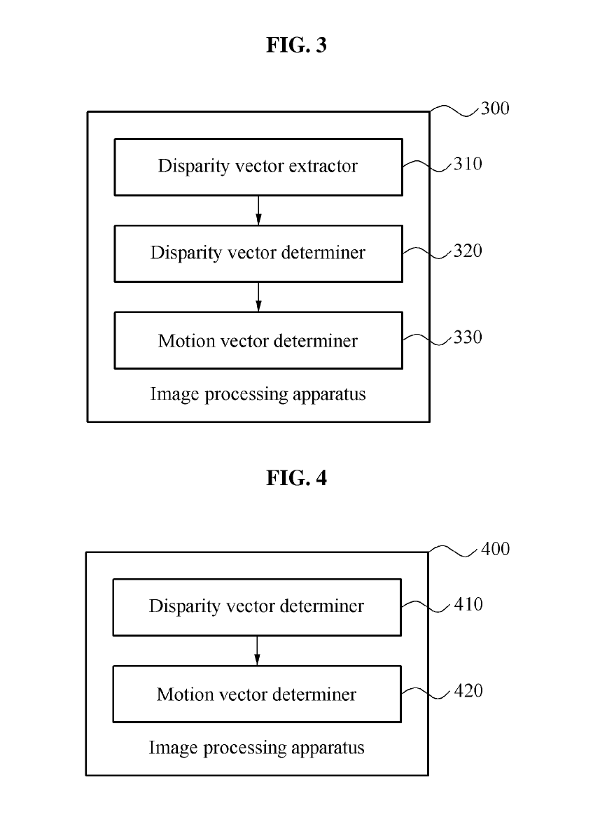

FIG. 3 is a block diagram illustrating an image processing apparatus for predicting a motion vector of a current block according to an example embodiment.

Referring to FIG. 3, an image processing apparatus 300 may include a disparity vector extractor 310 and a disparity vector determiner 320. The image processing apparatus 300 may predict a disparity vector of the current block using the disparity vector extractor 310 and the disparity vector determiner 320. According to another embodiment, the image processing apparatus 300 may further include a motion vector determiner 330, and may predict a motion vector of the current block using the motion vector determiner 330.

The disparity vector extractor 310 may extract a disparity vector of a neighbor block adjacent to a current block of a color image. For example, the disparity vector extractor 310 may determine whether a disparity vector is present in the neighbor block, and may determine the disparity vector of the neighbor block using a depth image corresponding to the color image when the disparity is absent in the neighbor block. According to another embodiment, the disparity vector extractor 310 may immediately determine the disparity vector of the neighbor block based on depth information of the depth image, without determining whether or not the disparity vector is present in the neighbor block.

The disparity vector extractor 310 may identify at least one pixel from among pixels included in the depth image corresponding to the current block. The disparity vector extractor 310 may convert the largest depth value among depth values of identified pixels to a disparity vector, and may determine the converted disparity vector as the disparity vector of the neighbor block. Alternatively, the disparity vector extractor 310 may use only a portion of pixels included in the depth image, and may convert the largest depth value among depth values of the portion of pixels to the disparity vector of the neighbor block.

For example, when a neighbor block does not have a disparity vector, the disparity vector extractor 310 may convert the largest depth value among depth values of one or more pixels included in a corresponding block of the depth image corresponding to the current block, to the disparity vector of the neighbor block, thereby estimating or predicting the disparity vector of the neighbor block. Alternatively, the disparity vector extractor 310 may identify a depth value of a pixel located within a predetermined area within the depth image, and may convert the largest depth value among depth values of pixels located in the predetermined area to the disparity vector of the neighbor block. For example, the disparity vector extractor 310 may convert the largest depth value among depth values of pixels located at corners of the corresponding block and a depth value located at the center of the corresponding block to the disparity vector of the neighbor block.

The disparity vector extractor 310 may determine the disparity vector of the neighbor block based on a macroblock including the corresponding block of the depth image. For example, the disparity vector extractor 310 may convert the largest depth value among depth values of pixels included in the macroblock to a disparity vector, and may determine the converted disparity vector as the disparity vector of the neighbor block. Alternatively, the disparity vector extractor 310 may convert, to the disparity vector of the neighbor block, the largest depth value among depth values of predetermined pixels included in the macroblock including the corresponding block. For example, the disparity vector extractor 310 may determine the disparity vector of the neighbor block by converting the largest depth value among depth values of pixels located at corners of the macroblock.

The disparity vector extractor 310 may use only a predetermined pixel within the depth image corresponding to the current color image to determine the disparity vector of the neighbor block. For example, the disparity vector extractor 310 may convert a depth value of a predetermined single pixel included in the depth image, to a disparity vector, and may determine the converted disparity vector as the disparity vector of the neighbor block.

The disparity vector determiner 320 may determine the disparity vector of the current block based on the disparity vector of the neighbor block. For example, the disparity vector determiner 320 may apply a median filter to the determined disparity vector of the neighbor block, and may determine a median filtered result as the disparity vector of the current block.

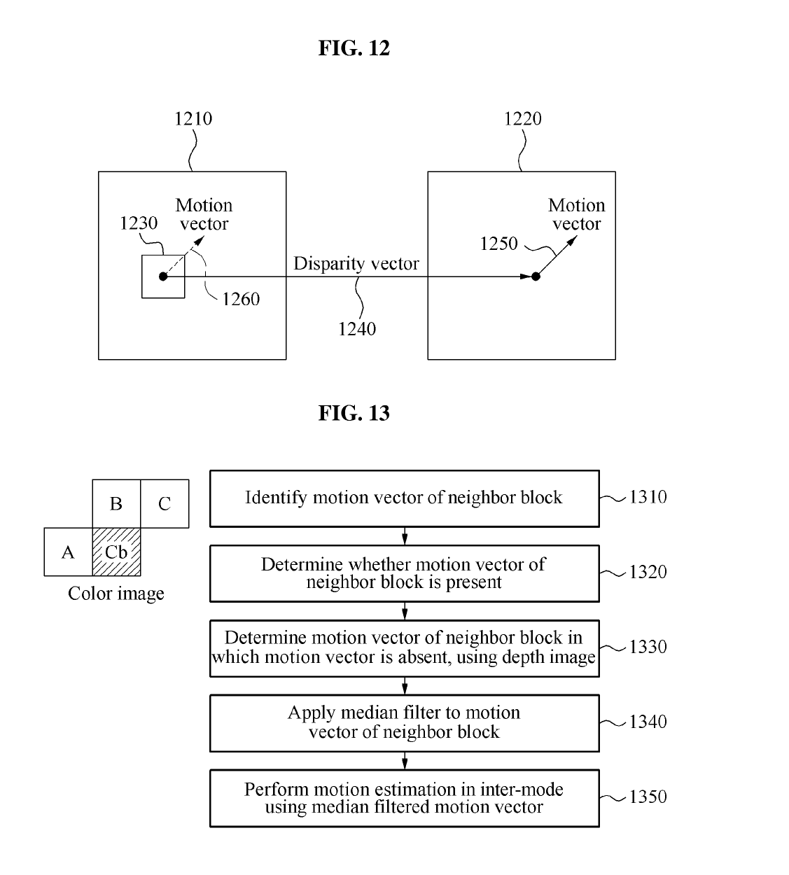

The motion vector determiner 330 may determine a motion vector of the current block based on the determined disparity vector of the current block. In detail, the motion vector determiner 330 may identify a location in a neighbor color image of the color image including the current block using the disparity vector of the current block, and may determine a motion vector at the identified location as the motion vector of the current block (as shown in FIG. 12, for example).

When the motion vector is absent at the identified location of the neighbor color image, the motion vector determiner 330 may determine or estimate the motion vector of the current block using a neighbor block adjacent to the current block. The motion vector determiner 330 may determine the motion vector of the current block based on at least one of the motion vector and the disparity vector of the neighbor block. For example, when an index of a reference image indicates a color image of the same view, the motion vector determiner 330 may apply a median filter to a motion vector of the neighbor block and may determine a median filtered result as the motion vector of the current block. In contrast, when an index of a reference image indicates a color image of a different view, the motion vector determiner 330 may determine a result of applying the median filter to the disparity vector of the neighbor block as the motion vector of the current block. In other cases aside from the above two cases, the motion vector determiner 330 may determine a zero motion vector as the motion vector of the current block.

FIG. 4 is a block diagram illustrating an image processing apparatus for predicting a motion vector of a current block according to another example embodiment.

The image processing apparatus 400 may include a disparity vector determiner 410 and a motion vector determiner 420.

The disparity vector determiner 410 may determine a disparity vector of a current block using a disparity vector of a neighbor block adjacent to a current block of a color image. For example, the disparity vector determiner 410 may determine whether or not a disparity vector is present in the neighbor block, and may determine the disparity vector of the neighbor block using a depth image corresponding to the color image when the neighbor block does not have a disparity vector. According to another embodiment, the disparity vector determiner 410 may also immediately determine the disparity vector of the neighbor block based on depth information of the depth image, without determining whether or not the disparity vector is present in the neighbor block.

The disparity vector determiner 410 may identify at least one pixel from among pixels included in the depth image corresponding to the current block. The disparity vector determiner 410 may convert the largest depth value among depth values of identified pixels to a disparity vector, and may determine the converted disparity vector as the disparity vector of the neighbor block. The disparity vector determiner 410 may also use only a portion of pixels included in the depth image, and may convert the largest depth value among depth values of the portion of pixels to the disparity vector of the neighbor block.

For example, when the neighbor block does not have a disparity vector, the disparity vector determiner 410 may determine or estimate a disparity vector of the neighbor block based on a depth value of at least one pixel included in a corresponding block of the depth image corresponding to the current block of the color image, and may determine a disparity vector of the current block based on the estimated disparity vector of the neighbor block. The disparity vector determiner 410 may convert the largest depth value among depth values of one or more pixels included in the corresponding block of the depth image, to the disparity vector of the neighbor block. Alternatively, the disparity vector determiner 410 may convert the largest depth value among depth values of pixels located in a predetermined area of the depth image to the disparity vector of the neighbor block.

According to another example, the disparity vector determiner 410 may also determine the disparity vector of the neighbor block based on a macroblock including the corresponding block of the depth image. For example, the disparity vector determiner 410 may convert, to a disparity vector, the largest depth value among depth values of pixels included in the macroblock, and may determine the converted disparity vector as the disparity vector of the neighbor block. Alternatively, the disparity vector determiner 410 may convert, to the disparity vector of the neighbor block, the largest depth value among depth values of pixels included in the macroblock including the corresponding block. For example, the disparity vector determiner 410 may determine the disparity vector of the neighbor block by converting the largest depth value among depth values of pixels located at corners of the macroblock.

In another example, the disparity vector determiner 410 may also use only a predetermined pixel within a depth image corresponding to a current color image to determine the disparity vector of the neighbor block. For example, the disparity vector determiner 410 may convert a depth value of a predetermined single pixel included in the depth image to a disparity vector, and may determine the converted disparity vector as the disparity vector of the neighbor block.

The disparity vector determiner 410 may determine a disparity vector of the current block based on the disparity vector of the neighbor block. For example, the disparity vector determiner 410 may apply a median filter to the disparity vector of the neighbor block, and may determine a median filtered result as the disparity vector of the current block.

The motion vector determiner 420 may determine a motion vector of the current block using the determined disparity vector of the current block. The motion vector determiner 420 may identify a location in a neighbor color image of the color image including the current block, using the disparity vector of the current block, and may determine a motion vector at the identified location as the motion vector of the current block.

When the motion vector is absent at the identified location of the neighbor color image, the motion vector determiner 420 may determine the motion vector of the current block using the neighbor block of the current block. The motion vector determiner 420 may determine the motion vector of the current block based on at least one of the motion vector and the disparity vector of the neighbor block. When the motion vector determiner 420 is unable to determine the motion vector of the current block using the motion vector or the disparity vector of the neighbor block, the motion vector determiner 420 may determine a zero motion vector as the motion vector of the current block.

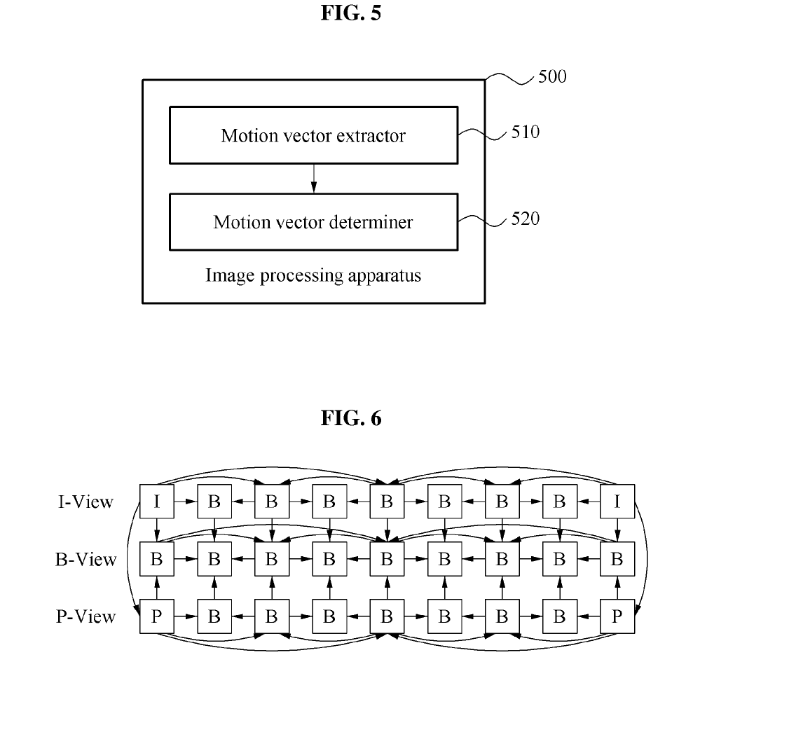

FIG. 5 is a block diagram illustrating an image processing apparatus for predicting a motion vector of a current block according to still another example embodiment.

Referring to FIG. 5, an image processing apparatus 500 may include a motion vector extractor 510 and a motion vector determiner 520.

The motion vector extractor 510 may extract a motion vector of a neighbor block adjacent to a current block of a color image. The motion vector extractor 510 may determine whether or not a motion vector is present in the neighbor block, and may determine the motion vector of the neighbor block using a depth image of the color image when the neighbor block does not have a motion vector. The motion vector extractor 510 may acquire the motion vector of the neighbor block in which the motion vector is absent, from a color image of a different view, and may use a depth image to acquire the motion vector of the neighbor block from the color image of the different view. According to another embodiment, the motion vector extractor 510 may immediately determine the motion vector of the neighbor block based on depth information of the depth image, without determining whether the motion vector is present in the neighbor block.

To determine the motion vector of the neighbor block, the motion vector extractor 510 may acquire a disparity vector using the depth image. The motion vector extractor 510 may identify at least one pixel included in the depth image corresponding to the current block, and may acquire the disparity vector based on a depth value of the identified at least one pixel. For example, the motion vector extractor 510 may convert, to a disparity vector, the largest depth value among depth values of one or more pixels included in a corresponding block of the depth image, which corresponds to the current block. The motion vector extractor 510 may use camera parameter information during a process of acquiring the disparity vector. The motion vector extractor 510 may estimate the motion vector of the neighbor block from a neighbor color image of the color image including the current block, using the disparity vector. Alternatively, the motion vector extractor 510 may convert, to a disparity vector, the largest depth value among depth values of pixels located in a predetermined area of the depth image corresponding to the current block, and may estimate the motion vector of the neighbor block from the neighbor color image of the color image including the current block, using the converted disparity vector.

The motion vector extractor 510 may determine the motion vector of the neighbor block based on a macroblock including the corresponding block of the depth image. For example, the motion vector extractor 510 may convert the largest depth value among depth values of pixels included in the macroblock, to a disparity vector, and may determine a motion vector at a location (e.g., a location in a neighbor color image) indicated by the converted disparity vector, as the motion vector of the neighbor block. Alternatively, the motion vector extractor 510 may convert, to the disparity vector of the neighbor block, the largest depth value among depth values of pixels included in the macroblock including the corresponding block, and may estimate the motion vector of the neighbor block using the converted disparity vector.

The motion vector extractor 510 may also use only a predetermined pixel within a depth image corresponding to a current color image to determine the motion vector of the neighbor block. For example, the motion vector extractor 510 may convert a depth value of a predetermined single pixel included in the depth image to a disparity vector, and may determine a motion vector at a location indicated by the converted disparity vector, as the motion vector of the neighbor block.

When the motion vector is absent at the location indicated by the disparity vector, the motion vector extractor 510 may determine a zero motion vector as the motion vector of the neighbor block. In addition, when a reference image index of the current block differs from a reference image index taken from a color image of a different view, the motion vector extractor 510 may also determine a zero motion vector as the motion vector of the neighbor block.

The motion vector determiner 520 may determine the motion vector of the current block based on the motion vector of the neighbor block. For example, the motion vector determiner 520 may apply a median filter to the motion vector of the neighbor block and may determine a median filtered result as the motion vector of the current block.

FIG. 6 illustrates a structure of a multi-view image according to an example embodiment.

FIG. 6 shows a multi-view video coding (MVC) method for performing encoding using a group of picture (GOP) “8” when images of three views, for example, a left view, a center view, and a right view, are received according to an example embodiment. A GOP indicates a group of continuous images starting from an I-frame.

Since the concept of a hierarchical B picture or a hierarchical B frame is used for a temporal axis and a view axis during a multi-view image encoding process, the redundancy between images may be reduced.

The encoding apparatus 110 of FIG. 1 may sequentially encode a left image, also referred to as a left picture (I-view), a right image, also referred to as a right picture (P-view), and a center image, also referred to as a center picture (B-view), based on the structure of the multi-view image of FIG. 6, and thus, may encode images corresponding to three views.

During a process of encoding the left image, an area similar to the left image may be estimated from previous images using a motion estimation and temporal redundancy may be reduced using information about the estimated area. Since the right image to be encoded after the left image is encoded by referring to the encoded left image, inter-view redundancy using a disparity estimation as well as the temporal redundancy using the motion estimation may also be reduced. Additionally, since the center image is encoded using the disparity estimation by referring to all of the left image and the right image that are already encoded, the inter-view redundancy may be reduced.

Referring to FIG. 6, during the multi-view image encoding process, an image, for example, the left image, encoded without using an image of a different view may be defined as an I-view image. An image, for example, the right image, encoded by uni-directionally predicting an image of a different view may be defined as a P-view image. An image, for example, the center image, encoded by bi-directionally predicting images of different views may be defined as a B-view image.

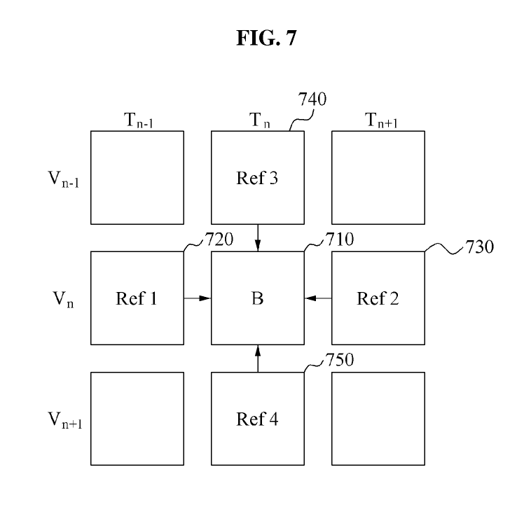

FIG. 7 illustrates a reference image used for coding a current block according to an example embodiment.

When encoding a current block included in a current color image, an image processing apparatus may use neighbor color images 720, 730, 740, and 750 as reference images. For example, the image processing apparatus may identify a similar block most similar to a current block from among the neighbor color images 720, 730, 740, and 750, and may encode a residual signal between the current block and the similar block. In the case of H.264/AVC, an encoding mode for estimating a similar block using a reference image may include SKIP (P Slice Only)/Direct (B Slice Only), 16×16, 16×8, 8×16, P8×8 modes, and the like. In the case of high efficiency video coding (HEVC), an encoding mode for estimating a similar block using a reference image may include SKIP, Merge, 2N×2N, 2N×N, N×2N modes, and the like.

During a process of encoding a current block, the image processing apparatus may use, as reference images, the neighbor color images 720 and 730 adjacent to the current color image based on a time in order to reduce the temporal redundancy. Further, to reduce the inter-view redundancy, the image processing apparatus may use, as reference images, the neighbor color images 740 and 750 adjacent to the current color image in terms of a view. The image processing apparatus may use the neighbor color images 720 and 730, that is, a Ref1 image and a Ref2 image, respectively, to acquire motion information, and may use the neighbor color images 740 and 750, that is, a Ref3 image and a Ref4 image, respectively, to acquire disparity information. That is, as an example, in FIG. 7, Vn−1, Vn, and Vn+1 may differ based on view, and Tn−1, Tn, and Tn+1 may differ based on time.

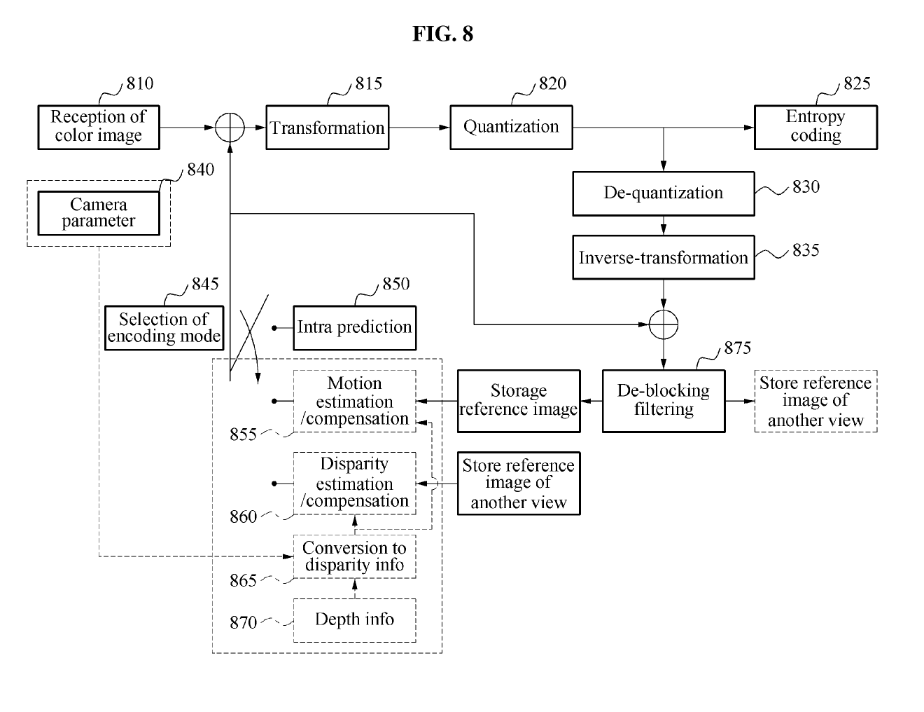

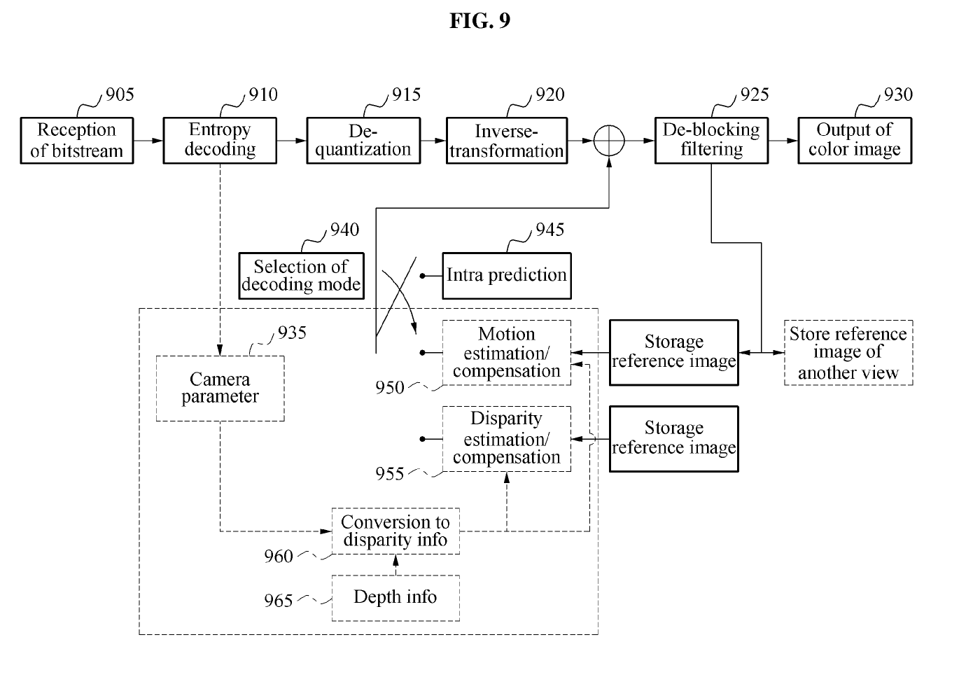

FIG. 8 is a diagram to describe an operation of an encoding apparatus according to an embodiment.

In detail, FIG. 8 illustrates a process of an encoding apparatus that encodes a color image. According to an embodiment, the color image encoding process of the encoding apparatus may be performed according to the operations of FIG. 8. The encoding apparatus may receive a color image in operation 810 and may select an encoding mode in operation 845. The encoding apparatus may determine a residual signal between the color image and a predicted image derived from a block prediction. The encoding apparatus may transform the residual signal in operation 815 and may perform quantization and entropy coding in operations 820 and 825.

The block prediction process may include a temporal prediction process for decreasing temporal redundancy and an inter-view prediction process for decreasing inter-view redundancy.

A de-blocking filtering process may be performed for accurate prediction in a subsequent color image in operation 875. In operations 830 and 835, a de-quantization process and an inverse transformation process may be performed on the image quantized in operation 820 to perform the de-blocking filtering process in operation 875. Reference images created through a de-blocking filtering process of operation 875 may be stored and be used for an encoding process of the subsequent color image.

The encoding apparatus may perform a prediction process to remove the temporal redundancy and the inter-view redundancy through an intra prediction 850, a motion estimation/compensation 855, or a disparity estimation/compensation 860. The image processing apparatus may perform a process of the motion estimation/compensation 855 and the disparity estimation/compensation 860. For the motion estimation/compensation 855, the image processing apparatus may convert depth information 870, for example, a depth value to disparity information, for example, a disparity vector based on a camera parameter 840 in operation 865, and may perform a process of the motion estimation/compensation 855. Alternatively, for the disparity estimation/compensation 860, the image processing apparatus may convert depth information 870, for example, a depth value to disparity information, for example, a disparity vector based on the camera parameter 840 in operation 865, and may perform a process of the disparity estimation/compensation 860.

According to an increase in a similarity between the prediction image derived through the block prediction and an original image, an amount of residual signal decreases, which may lead to decreasing the number of bits that are encoded, and thereby created and transmitted in the bitstream. Accordingly, to efficiently encode a 3D video, the process of the motion estimation/compensation 855 and the disparity estimation/compensation 860 is important.

The image processing apparatus may perform the process of the motion estimation/compensation 855 of the current block by using motion vector information of the neighbor block, encoding information about a color image of a different view, or the depth image corresponding to the current block during the process of the motion estimation/compensation 855. In addition, the image processing apparatus may perform the process of the disparity estimation/compensation 860 of the current block by using disparity vector information of the neighbor block, encoding information about a color image of a different view, or the depth image corresponding to the current block during the process of the disparity estimation/compensation 860.

FIG. 9 is a diagram to describe an operation of a decoding apparatus according to an embodiment.

The decoding apparatus may inversely perform the operation performed by the encoding apparatus of FIG. 8 to output a color image by decoding an encoded bitstream. According to an embodiment, a 3D image data decoding process of the decoding apparatus may be performed according to the operations of FIG. 9. The decoding apparatus may receive a bitstream including encoded 3D image data in operation 905, and may perform entropy decoding in operation 910.

The decoding apparatus may perform a process of de-quantization 915 and inverse transformation 920, and may select a decoding mode in operation 940. The decoding apparatus may efficiently decode the bitstream through a process of an intra prediction 945, a motion estimation/compensation 950, or a disparity estimation/compensation 955.

The image processing apparatus may perform the process of the motion estimation/compensation 950 and the disparity estimation/compensation 955. For the motion estimation/compensation 950, the image processing apparatus may convert depth information 950 to disparity information based on a camera parameter 935 in operation 960, and may perform the process of the motion estimation/compensation 950 using the conversion information. Alternatively, for the disparity estimation/compensation 955, the image processing apparatus may convert depth information 965 to disparity information based on the camera parameter 935 in operation 960, and may perform the process of the disparity estimation/compensation 955.

The image processing apparatus may perform the process of the motion estimation/compensation 950 of the current block by using motion vector information of the neighbor block, decoding information about a color image of a different view, or the depth image corresponding to the current block during the process of the motion estimation/compensation 950. In addition, the image processing apparatus may perform the process of the disparity estimation/compensation 955 of the current block by using disparity vector information of the neighbor block, decoding information about a color image of a different view, or the depth image corresponding to the current block during the process of the disparity estimation/compensation 955.

For decoding of a subsequent color image, a process of de-blocking filtering 925 may be performed. Reference images created through the process of de-blocking filtering 925 may be stored and be used for a decoding process of the subsequent color image.

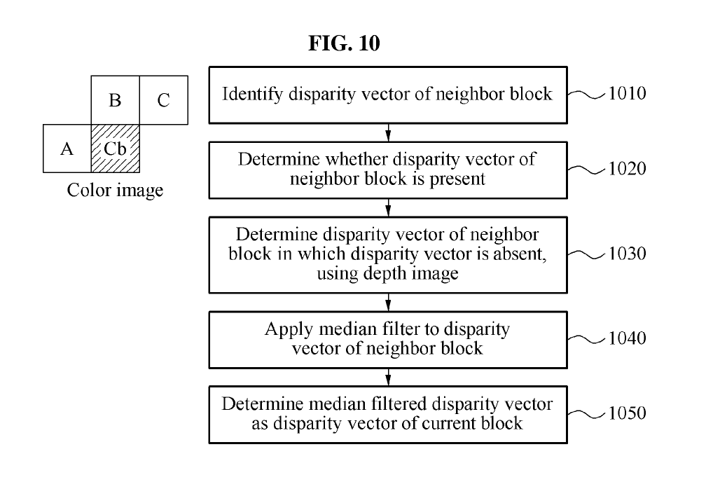

FIG. 10 is a diagram including a flowchart illustrating a process of predicting a disparity vector of a current block according to an example embodiment.

Referring to FIG. 10, a block Cb denotes a current block to be encoded in a color image. Blocks A, B, and C denote neighbor blocks present at locations adjacent to the current block. To predict a disparity vector of the current block, the image processing apparatus may identify disparity vectors of the neighbor blocks A, B, and C, and may apply a median filter to the identified disparity vectors.

When a neighbor block does not have a disparity vector among the neighbor blocks A, B, and C, the image processing apparatus may replace the disparity vector of the neighbor block in which the disparity vector is absent with a predetermined disparity vector. For example, it is assumed that a disparity vector is absent in the neighbor block A. To determine a disparity vector of the neighbor block A, the image processing apparatus may convert the largest depth value among depth values of pixels included in a depth image corresponding to the current block to a disparity vector. Alternatively, the image processing apparatus may convert the largest depth value among depth values of a portion of pixels included in the depth image to the disparity vector of the neighbor block A. For example, the image processing apparatus may convert, to a disparity vector, the largest depth value among depth values of pixels present in a predetermined area, such as corners within a corresponding block of the depth image corresponding to the current block.

Alternatively, the image processing apparatus may convert, to the disparity vector, the largest depth value among depth values of pixels located in a predetermined area, such as corners within a macroblock including the corresponding block of the depth image corresponding to the current block. The image processing apparatus may determine the converted disparity vector as the disparity vector of the neighbor block A, and may determine the disparity vector of the current block Cb by applying a median filter to disparity vectors of the neighbor blocks A, B, and C.

The image processing apparatus may determine the disparity vector of the current block Cb based on the macroblock including the corresponding block of the depth image. For example, the image processing apparatus may convert the largest depth value among depth values of pixels included in the macroblock to the disparity vector of the current block Cb, or may convert the largest depth value among depth values of predetermined pixels included in the macroblock to the disparity vector of the current block Cb. In addition, in another example, the image processing apparatus may also use only a predetermined pixel within the depth image corresponding to the current block Cb. For example, the image processing apparatus may convert a depth value of a single pixel included in the depth image corresponding to the current block Cb to a disparity vector, and may determine the converted disparity vector as the disparity vector of the current block Cb.

To convert the depth value to the disparity vector, the image processing apparatus may also use camera parameter information. Each of the disparity vector and the motion vector of the current block derived through FIG. 10 may be used as a predictive disparity vector based on 16×16, 16×8, 8×16, and P8×8 modes. The image processing apparatus may estimate a final disparity vector of the current block by performing a disparity estimation through the predictive disparity vector.

Hereinafter, a process of predicting, by the image processing apparatus, the disparity vector of the current block will be described.

In operation 1010, the image processing apparatus may identify disparity vectors of the neighbor blocks A, B, and C of the current block Cb. In operation 1020, the image processing apparatus may determine whether a disparity vector of a neighbor block is present.

When a disparity vector is absent from a neighbor block, the image processing apparatus may determine or estimate the disparity vector of the neighbor block in which the disparity vector is absent, using the depth image in operation 1030. For example, the image processing apparatus may identify at least one pixel from among pixels included in the depth image corresponding to the current block, may convert the largest depth value among depth values of identified pixels to a disparity vector, and may determine the converted disparity vector as the disparity vector of the neighbor block in which the disparity vector is absent. To determine the disparity vector of the neighbor block, the image processing apparatus may also use only a predetermined pixel within a depth image corresponding to a current color image. For example, the image processing apparatus may convert a depth value of a predetermined single pixel included in the depth image to a disparity vector, and may determine the converted disparity vector as the disparity vector of the neighbor block.

The image processing apparatus may convert the depth value to the disparity vector based on pixels within the corresponding block of the depth image corresponding to the current block or pixels within the macroblock including the corresponding block. For example, the image processing apparatus may convert the largest depth value among depth values of pixels included in the corresponding block of the depth image or the macroblock to the disparity vector of the neighbor block, or may convert the largest depth value among depth values of pixels located in a predetermined area of the corresponding block or the macroblock to the disparity vector of the neighbor block.

In operation 1040, the image processing apparatus may apply a median filter to the disparity vector of the neighbor block. In operation 1050, the image processing apparatus may determine a median-filtered disparity vector as the disparity vector of the current block Cb. The image processing apparatus may encode the disparity vector of the current block Cb.

In addition to the aforementioned process of replacing the disparity vector, another example embodiment is discussed herein. In detail, the image processing apparatus may immediately convert the largest depth value among depth values of pixels included in the corresponding block of the depth image corresponding to the current block Cb, without using the disparity vectors of the neighbor blocks A, B, and C of the current block Cb. Alternatively, for conversion of the disparity vector, the image processing apparatus may also use only depth values of a portion of pixels included in the corresponding block of the depth image corresponding to the current block Cb. For example, the image processing apparatus may convert, to a disparity vector, the largest depth value among depth values of pixels located at corners of the corresponding block and a pixel located at the center of the corresponding block. The image processing apparatus may use camera parameter information during a process of converting a depth value to a disparity vector. The image processing apparatus may determine the converted disparity vector as the disparity vector of the current block. In an embodiment, the determined disparity vector of the current block may provide an initial point during a disparity estimation process with respect to an inter-mode to reduce redundancy between different views.

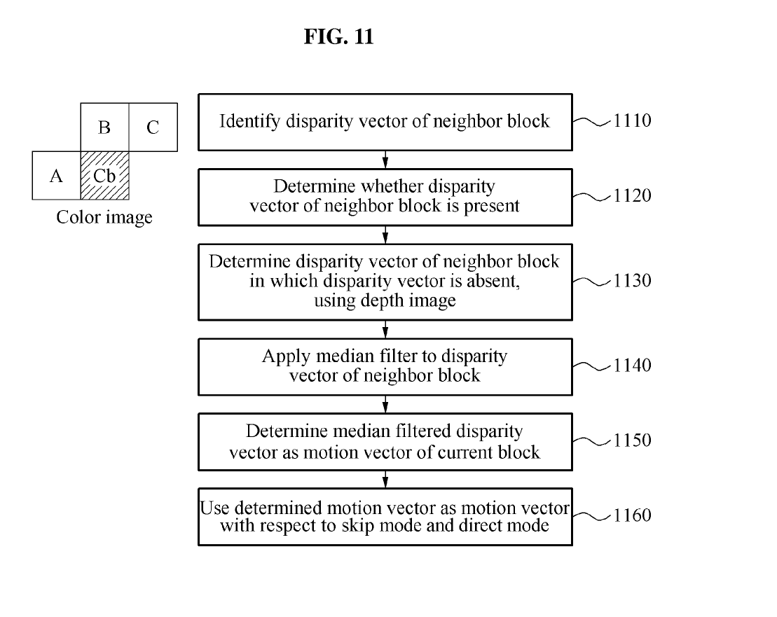

FIG. 11 is a diagram illustrating a process of predicting a motion vector of a current block with respect to a skip mode and a direct mode according to an example embodiment.

FIG. 11 illustrates a process of determining a final motion vector of a current block Cb in a color image with respect to a skip mode and a direct mode. In the skip mode and the direct mode, a motion estimation and a disparity estimation are not performed. Blocks A, B, and C denote neighbor blocks present at locations adjacent to the current block Cb.

The image processing apparatus may use disparity vectors of the neighbor blocks A, B, and C to predict the motion vector of the current block Cb. When encoding/decoding a P-view image or a B-view image, the image processing apparatus may use information of an already encoded/decoded I-view image to predict the motion vector with respect to the skip mode and the direct mode. Also, when a P-view image or a B-view image of a different view is already encoded/decoded, the image processing apparatus may also use the P-view image and the B-view image as well as an I-view image to predict the motion vector with respect to the skip mode and the direct mode.

In operation 1110, the image processing apparatus may identify a disparity vector of a neighbor block adjacent to the current block Cb in the color image. In operation 1120, the image processing apparatus may determine whether or not the disparity vector of the neighbor block is present.

When a disparity vector is absent from a neighbor block, the image processing apparatus may determine the disparity vector of the neighbor block in which the disparity vector is absent using the depth image in operation 1130. The image processing apparatus may identify at least one pixel from among pixels included in the depth image corresponding to the current block Cb, and may convert the largest depth value among depth values of identified pixels to the disparity vector. The image processing apparatus may determine the converted disparity vector as the disparity vector of the neighbor block in which the disparity vector is absent. Also, the image processing apparatus may use only depth values of a portion of pixels included in the depth image to convert the depth value to the disparity vector. For example, the image processing apparatus may convert a depth value of a predetermined single pixel included in the depth image corresponding to the current block Cb, and may determine the converted disparity vector as the disparity vector of the neighbor block. The image processing apparatus may use camera parameter information during a process of converting the depth value to the disparity vector.

The image processing apparatus may determine the disparity vector of the neighbor block based on the corresponding block of the depth image corresponding to the current block or the macroblock including the corresponding block. For example, the image processing apparatus may convert the largest depth value among depth values of pixels included in the corresponding block or the macroblock to the disparity vector of the neighbor block, or may convert the largest depth value among depth values of predetermined pixels included in the corresponding block or the macroblock to the disparity vector of the neighbor block.

In operation 1140, the image processing apparatus may apply a median filter to the disparity vector of the neighbor block. In operation 1150, the image processing apparatus may determine the motion vector of the current block Cb using the median filtered disparity vector. In detail, the image processing apparatus may determine a motion vector at a location indicated by the median filtered disparity vector, as the motion vector of the current block Cb. For example, when the median filtered disparity vector indicates an I-view image, the image processing apparatus may identify a location indicated by the median filtered disparity vector in the I-view image that is present in the same time zone as the current color image, and may use motion information at the identified location of the I-view image to determine the motion vector of the current block Cb.

When the motion vector is absent at the location indicated by the median filtered disparity vector, the image processing apparatus may determine the motion vector of the current block Cb using the neighbors block A, B, and C of the current block Cb. The image processing apparatus may use, as a reference image index of the current block Cb, the smallest index among reference image indices of the neighbor blocks A, B, and C. For example, in the case of a P-picture, a reference image index is “0”.

When the reference image index indicates a color image of the same view, the image processing apparatus may determine a result of applying a median filter to motion vectors of the neighbor blocks A, B, and C as the motion vector of the current block Cb. When the reference image index indicates a color image of a different view, the image processing apparatus may determine a result of applying a median filter to disparity vectors of the neighbor blocks A, B, and C as the motion vector of the current block Cb. In other cases aside from the above two cases, the image processing apparatus may determine a zero motion vector as the motion vector of the current block Cb.

In operation 1160, the image processing apparatus may use the determined motion vector of the current block Cb as the motion vector with respect to the skip mode and the direct mode. Also, the image processing apparatus may use a reference image index at the location indicated by the median filtered disparity vector as a reference image index in the skip mode and the direct mode.

FIG. 12 is a diagram illustrating a process of predicting a motion vector of a current block using a disparity vector according to an example embodiment.

Referring to FIG. 12, the image processing apparatus may determine or estimate a motion vector 1260 of a current block 1230 using a disparity vector 1240 of the current block 1230 in a current color image 1210. For example, the image processing apparatus may apply a median filter to disparity vectors of neighbor blocks to determine the disparity vector 1240 of the current block 1230. The image processing apparatus may identify a location within a reference image 1220 indicated by the median filtered disparity vector 1240, and may determine the motion vector 1250 at the identified location as the motion vector 1260 of the current block 1230. When the motion vector is absent at the identified location indicated by the median filtered disparity vector, the image processing apparatus may determine the motion vector of the current block Cb using the neighbor blocks A, B, and C of the current block Cb.

FIG. 13 is a diagram illustrating a process of predicting a motion vector of a current block with respect to an inter-mode according to an example embodiment.

Referring to FIG. 13, a block Cb denotes a current block to be encoded in a color image. Blocks A, B, and C denote neighbor blocks present at locations adjacent to the current block Cb. To predict a motion vector of the current block Cb, the image processing apparatus may use motion vectors of the neighbor blocks A, B, and C.

In operation 1310, the image processing apparatus may identify a motion vector of a neighbor block of the current block Cb. In operation 1320, the image processing apparatus may determine whether or not the motion vector of the neighbor block is present.

When a neighbor block does not have a motion vector, the image processing apparatus may determine or estimate the motion vector of the neighbor block in which the motion vector is absent using the depth image in operation 1330. The image processing apparatus may acquire the motion vector of the neighbor block in which the motion vector is absent, from a color image of a different view. To this end, the image processing apparatus may use the depth image.

The image processing apparatus may identify at least one pixel among pixels included in the depth image corresponding to the current block Cb, and may convert the largest depth value among depth values of identified pixels to the disparity vector. To convert the depth value to the disparity vector, the image processing apparatus may also use only depth values of a portion of pixels included in the depth image. For example, the image processing apparatus may convert, to a disparity vector, the largest depth value among depth values of pixels included in the corresponding block of the depth image corresponding to the current block Cb.

Alternatively, the image processing apparatus may convert, to the disparity vector, the largest depth value among depth values of four pixels located at corners within the corresponding block and a depth value of a pixel located at the center of the corresponding block. The image processing apparatus may use camera parameter information during a process of converting the depth value to the disparity vector. The image processing apparatus may determine a motion vector of the neighbor block using the disparity vector. The image processing apparatus may determine a motion vector at a location indicated by the disparity vector as the motion vector of the neighbor block.

In another example, the image processing apparatus may determine the motion vector of the neighbor block based on the macroblock including the corresponding block of the depth image. For example, the image processing apparatus may convert the largest depth value among depth values of pixels included in the macroblock to a disparity vector, and may determine a motion vector at a location indicated by the converted disparity vector as the motion vector of the neighbor block. Alternatively, the image processing apparatus may convert the largest depth value among depth values of predetermined pixels included in the macroblock including the corresponding block to the disparity vector of the neighbor block, and may estimate the motion vector of the neighbor block using the converted disparity vector.

In another example, to determine the motion vector of the neighbor block, the image processing apparatus may use only a predetermined pixel within the depth image corresponding to the current color image. For example, the image processing apparatus may convert, to the disparity vector, a depth value of a predetermined single pixel included in the depth image corresponding to the current color image, and may determine or estimate a motion vector at a location indicated by the converted disparity vector as the motion vector of the neighbor block.

When a reference image index of the current block Cb differs from a reference image index taken from a color image of a different view, the image processing apparatus may determine a zero motion vector as the motion vector of the neighbor block. For example, when a disparity vector created through conversion of a depth value indicates an I-view image, the image processing apparatus may identify a location indicated by the disparity vector in the I-view image that is in the same time zone as the current color image, and may use motion information at the identified location to determine the motion vector of the current block Cb. When the motion vector is absent at the location indicated by the disparity vector, the image processing apparatus may use a zero motion vector as the motion vector of the neighbor block.

In operation 1340, the image processing apparatus may determine the motion vector of the current block Cb by applying a median filter to the motion vector of the neighbor block. In operation 1350, the image processing apparatus may perform a motion estimation in the inter-mode using the median filtered motion vector. The image processing apparatus may use the median filtered motion vector as a predictive motion vector in the inter-mode. The predictive motion vector may provide an initial point when performing a motion estimation in the inter-mode.

According to an example embodiment, the description made above with reference to FIGS. 10 through 13 may be configured as follows:

<1.1: Derivation Process about Motion Vector Components and Reference Indices>

1) Input during this process:
macroblock partition mbPartIdx
sub-macroblock partition subMbPartIdx.

2) Output during this process:
If ChromaArrayType is not “0”, luma motion vectors mvL0 and mvL1, and chroma motion vectors mvCL0 and mvCL1,
reference indices refIdxL0 and refIdxL1,
prediction list utilization flags predFlagL0 and predFlagL1,
motion vector count variable subMvCnt.

3) The following content may be applicable to derive variables refIdxL0, refIdxL1, mvL0, and mvL1.

A. If mb_type is equal to P_Skip,
a) If MbVSSkipFlag is equal to “0”,
If nal_unit_type is equal to “21”, DepthFlag is equal to “0”, and dmvp_flag is equal to “1”, a depth based derivation process about luma motion vectors of skipped macroblocks included in P slice and SP slice in subclause 1.1.1 is invoked and in this instance, has an output that luma motion vector mvL0, reference index refIdxL0, and predFlagL0 are set to “1”.
Otherwise (if nal_unit_type is not equal to “21”, or if DepthFlag is equal to “1,” or if dmvp_flag is equal to “0”), a depth based derivation process about luma motion vectors of skipped macroblocks included in P slice and SP slice in a subclause (J.8.4.1.1) is invoked and in this instance, has an output that luma motion vector mvL0, reference index refIdxL0, and predFlagL0 are set to “1”.

b) If MbVSSkipFlag is equal to “1”,
a derivation process about luma motion vectors of VSP skipped macroblocks included in P slice and SP slice in subclause 1.1.2 is invoked and in this instance, has an output that luma motion vector mvL0, reference index refIdxL0, and predFlagL0 are set to “1”.

c) If mvL1 and refIdxL1 are marked to be unavailable and predFlagL1 is equal to “0”, motion vector count variable subMvCnt is set to “1”.

B. If mb_type is equal to B_Skip or B_Direct_{—}16×16, or if sub_mb_type [mbPartIdx] is equal to B_Direct_{—}8×8, the following contents are applied.
a) Variable vspFlag is embodied as expressed by the following Table 1.

TABLE 1

vspFlag = ! ((mb_type = = B_Skip && MbVSSkipFlag = = 0) | | ((mb_type = = B_Direct_16×16 |
| sub type[mbPartIdx] = = B_Direct_8×8) && !mb_direct_type_flag))

b) If vspFlag is equal to “0”, nal_unit_type is equal to “21”, DepthFlag is equal to “0”, and dmvp_flag is equal to “1”, a depth based derivation process about luma motion vectors of B_Skip, B_Direct_{—}16×16, and B_Direct_{—}8×8 included in B slices in subclause 1.1.3 is invoked and in this instance, has an input of mbPartIdx and subMbPartIdx and has an output of luma motion vectors mvL0 and mvL1, reference indices refIdxL0 and refIdxL1, motion vector count variable subMvCnt, and prediction list utilization flags predFlagL0 and predFlagL1.
c) If vspFlag is equal to “0”, and nal_unit_type is not equal to “21”, or DepthFlag is equal to “1”, or dmvp_flag is equal to “0”, a derivation process about luma motion vectors B_Skip, B_Direct_{—}16×16, and B_Direct_{—}8×8 included in B slices in a subclause (J.8.4.1.2) is invoked and in this instance, has an input of mbPartIdx and subMbPartIdx and has an output of luma motion vectors mvL0 and mvL1, reference indices refIdxL0 and refIdxL1, motion vector count variable subMvCnt, and prediction list utilization flags predFlagL0 and predFlagL1.
d) If vspFlag is equal to “1”, a derivation process about luma motion vectors of B_Skip, B_Direct_{—}16×16, and B_Direct_{—}8×8 included in B slices in subclause 1.1.6 is invoked.

In a subclause (J.8.4.1),

If predFlagLX is equal to “1”, DepthFlag is equal to “0”, and dmvp_flag is equal to “1”, a derivation process about luma motion vector prediction in subclause 8.3.1.7 is invoked and in this instance, has an input of mbPartIdx, subMbPartIdx, refIdxLX, and currSubMbType, and has an output of mvpLX. If predFlagLX is equal to “1” and DepthFlag is equal to “1”, or dmvp_flag is equal to “0”, a derivation process about luma motion vector prediction in subclause 8.4.1.3 is invoked and in this instance, has an input of mbPartIdx, subMbPartIdx, refIdxLX, and currSubMbType, and has an output of mvpLX.

<1.1.1: Derivation Process about Luma Motion Vectors of Skipped Macroblocks in P Slice and SP Slice>

If mb_type is equal to P_Skip, nal_unit_type is equal to “21”, DepthFlag is equal to “0”, dmvp_flag is equal to “1”, and MbVSSkipFlag is equal to “0”, this process is invoked.

1) Output of this process:
motion vector mvL0,
reference index refIdxL0.

2) For derivation of refIdxL0 of P_Skip macroblock type and motion vector mvL0, the following operations are embodied.

a. A process specified in subclause 1.1.5 is invoked. In this instance, as an input, mbPartIdx is set to “0”, subMbPartIdx is set to “0”, currSubMbType is set to “na”, and listSuffixFlag is set to “0”. As an output, motion vector mvL0 and reference index refIdxL0 are allocated.

b. If refIdxL0 is equal to “−1”:
Reference index refIdxL0 for skipped macroblock is derived as refIdxL0=0.
A derivation process about luma motion vector prediction in subclause 1.1.7 is invoked.
   In this instance, mbPartIdx=0, subMbPartIdx=0, refIdxL0, and currSubMbType=“na” are set as an input, and mvL0 is set as an output.

<1.1.2: Derivation Process about Luma Motion Vectors of VSP Skipped Macroblocks Included in P Slice and SP Slice>

If mb_type is equal to P_Skip, nal_unit_type is equal to “21”, DepthFlag is “0”, and MbVSSkipFlag is “1”, this process is invoked.

An output of this process is motion vector mvL0 and reference index refIdxL0.

Reference index refIdxL0VSP for VSP skipped macroblock is acquired as a synthetic picture appearing first of RefPicList0.

<1.1.3: Derivation Process about Luma Motion Vectors of B_Skip, B_Direct_{—}16×16, and B_Direct_{—}8×8>

An input of this process is partition indices mbPartIdx and subMbPartIdx of a current macroblock.

An output of this process is reference indices refIdxL0 and refIdxL1, motion vectors mvL0 and mvL1, motion vector count variable subMvCnt, and prediction list utilization flags predFlagL0 and predFlagL1.

The following operations are specified to drive an output.

1. Variable currSubMbType is set to be equal to sub_mb_type[mbPartIdx].

2. A process specified in subclause 1.1.5 is invoked. In this instance, mbPartIdx=0, subMbPartIdx=0, and currSubMbType and listSuffixFlag=0 are set as an input. Motion vector mvL0 and reference index refIdxL0 are allocated as an output.

3. A process specified in subclause 1.1.5 is invoked. In this instance, mbPartIdx is set to “0”, subMbPartIdx is set to “0”, and currSubMbType and listSuffixFlag are set to “1”. Motion vector mvL1 and reference index refIdxL1 are allocated as an output.

4. If reference indices refIdxL0 and refIdxL1 are equal to “−1”, the following process is applied.
Reference indices refIdxL0 and refIdxL1 are derived according to the following Table 2.

TABLE 2

```
refIdxL0 = MinPositive(refIdxL0A, minPositive(refIdxL0B, refIdxl0C)).
refIdxL1 = MinPositive(refIdxL1A, minPositive(refIdxL1B, refIdxl1C)).
    where
      MinPositive(x, y) =
  -When both reference indices refIdxL0 and refIdxL1 are less than 0,
        refIdxL0 = 0
```

A derivation process about luma motion vector prediction in subclause 1.1.7 is invoked.
   In this instance, mbPartIdx=0, subMbPartIdx=0, refIdxLX (X=0 or 1), and currSubMbType are set as an input, and mvLX is allocated as an output.

<1.1.4: Derivation Process about Disparity Vector and Inter-View Reference>

During this process, an input includes depth reference view component depthPic, a location of top-left sample (dbx1, dby1) of a partition, and listSuffixFlag.

During this process, an output includes picture InterViewPic, offset vector dv, and variable InterViewAvailable.

InterViewAvailable is set to “0”.

The following Table 3 is applied to acquire InterViewPic that is an inter-view only reference picture or an inter-view reference picture in a state in which listFuffixFlag is “1” or “0” otherwise and X is set to “1”.

TABLE 3

```
  for(cIdx = 0;cIdx<num_ref_idx_l0_active_minus1 + 1 && !InterViewAvailable; cIdx
++)
    if (view order index of RefPicList0[cIdx] is equal to 0) {
    InterViewPic = RefPicList0[cIdx]
    InterViewAvailable = 1
      }
```

If InterViewAvailable=“1”, the following operations are sequentially applied.
A process specified in a subclause (8.4.1.3.2) is invoked. In this instance, as an input, mbPartIdx is set to “0”, subMbPartIdx is set to “0”, currSubMbType is set to “na”, and listSuffixFlag is set to “0”. Also, reference indices refIdxCandL0[i] and motion vectors mvCandL0[i] are set as an output. Here, i has a value of “0”, “1”, or “2” corresponding to each of neighboring partitions A, B, and C.
A process specified in a subclause (8.4.1.3.2) is invoked. In this instance, as an input, mbPartIdx is set to “0”, subMbPartIdx is set to “0”, currSubMbType is set to “na”, and listSuffixFlag is set to “1”. Also, reference indices refIdxCandL1[i] and motion vectors mvCandL1 [i] are set as an output. Here, i has a value of “0”, “1”, or “2” corresponding to each of neighboring partitions A, B, and C.

Variable dv is determined according to the following operations.
DvAvailable[i] is set according to the following Table 4. Here, i has a value of “0”, “1”, or “2” corresponding to each of neighboring partitions A, B, and C.

TABLE 4

```
for(i = 0 ; i<3 ; i ++)
  if (view order index of RefPicList0[refIdxCandLX[i]] is equal to 0) {
    DvAvailable[i] = 1
  }
```

If any one of DvAvailable[0], DvAvailable[1], and DvAvailable[2] is equal to “1”,
   dv[0]=mvCandLX[i][0]
   dv[1]=mvCandLX[i][1].
Otherwise, the following operations are sequentially applied.
   1. Variable maxDepth is set as expressed by the following Table 5.

TABLE 5

```
  maxDepth = INT_MIN
  for(j = 0; j < partHeight; j+=(partHeight−1))
  for(i = 0; i < partWidth; i+=(partWidth−1))
    if(depthPic[dbx1 + i, dby1 + j] > maxDepth) maxDepth =
    depthPic[dbx1 + i,
dby1 + j]
```

2. Variable disp is set as expressed by the following Table 6.

TABLE 6

```
  index = ViewIdTo3DVAcquisitionParamindex(view_id of the
  current view)
  refindex = ViewIdTo3DVAcquisitionParamindex(view_id of the
  InterViewPic)
  disp[0] = Disparity(NdrInverse[maxDepth], ZNear[dps_id, index],
  ZFar[dps_id,
index],
    FocalLengthX[dps_id, index], AbsTX[index] − AbsTX[refindex])
  disp[1] = 0
```

3. If DvAvailable[i] is equal to “0”,
   mvCandLX[i]=disp
4. Components of variable dv are given as median values of corresponding vector components of motion vectors mvCandLX[0], mvCandLX[1], and mvCandLX[2], respectively.

dv[0]=Median(mvCandLX[0][0], mvCandLX[1][0], and mvCandLX[2][0])

dv[1]=Median(mvCandLX[0][1], mvCandLX[1][1], and mvCandLX[2][1])

<1.1.5: Derivation Process about Inter-View Motion Vector in Inter-View Reference>

During this process, an input includes mbPartIdx, subMbPartIdx, and listSuffixFlag.

During this process, an output includes motion vector mvCorrespondand and reference index refIdxCorrespond.

Inter-view reference picture InterViewPic and offset vector dv are derived according to the following operations.
An inverse macroblock scanning process is invoked. In this instance, CurrMbAddr is set to an input and (x1, y1) is allocated as an output.
An inverse macroblock partition scanning process is invoked. In this instance, mbPartIdx is set as an input and (dx1, dy1) is allocated as an output.
An inverse sub-macroblock partition scanning process is invoked. In this instance, mbPartIdx and subMbPartIdx are set as an input and (dx2, dy2) is allocated as an output.
A process specified in subclause 1.1.4 is invoked. In this instance, DepthCurrPic, dbx1 set to x1+dx1+dx2, dby1 set to y1+dy1+dy2, and listSuffixFlag are set as an input, and InterViewPic, offset vector dv, and variable InterViewAvailable are allocated as an output.

refIdxCorrespond and mvCorrespond may be set as follows.
If InterViewAvailable is equal to “0”, refIdxCorrespond is set to “−1” and all of mvCorrespond [0] and mvCorrespond [1] are set to “0”.
Otherwise, the following operations are sequentially applied.
   Variable luma4×4BlkIdx is derived as expressed by (4*mbPartIdx+subMbPartIdx).
   An inverse 4×4 luma block scanning process is invoked. In this instance, luma4×4BlkIdx is set as an input and (x, y) is allocated as an output. Also, (xCorrespond, yCorrespond) is set to (x+(dv[0]>>4), y+(dv [1]>>4)) and mbAddrCorrespond is set to ((CurrMbAddr/PicWidthInMbs)+(dv[1]>>6))*PicWidthInMbs+(CurrMbAddr % PicWidthInMbs)+(dv[0]>>6).
   mbTypeCorrespond is set to syntax element mb_type of a macroblock having an address of mbAddrCorrespond within picture InterViewPic. If mbTypeCorrespond is equal to P_{—}8×8, P_{—}8×8ref0, or B_{—}8×8, subMbTypeCorrespond is set to syntax element sub_mb_type of a macroblock having an address of mbAddrCorrespond within picture InterViewPic.
   mbPartIdxCorrespond is set to a macroblock partition index of a corresponding partition and subMbPartIdxCorrespond is set to a sub-macroblock partition index of a sub-macroblock partition. A derivation process about the macroblock partition index and the sub-macroblock partition index is invoked. In this instance, a luma location equal to (xCorrespond, yCorrespond), a macroblock type equal to mbTypeCorrespond, and list subMbTypeCorrespond of the sub-macroblock type when mbTypeCorrespond is equal to P_{—}8×8, P_{—}8×8ref0, or B_{—}8×8 are set as an input. Also, macroblock partition index mbPartIdxCorrespond and sub-macroblock partition index subMbPartIdxCorrespond are allocated as an output.
   Motion vector mvCorrespond and reference index refIdxCorrespond are determined as follows.
      When macroblock mbAddrCorrespond is encoded using an intra prediction mode, components of mvCorrespond are set to “0” and components of refIdxCorrespond are set to “−1”.
      Otherwise (when macroblock mbAddrCorrespond is not encoded using an intra prediction mode), prediction utilization flags predFlagLXCorrespond is set equal to PredFlagLX[mbPartIdxCorrespond], a prediction utilization flag of macroblock partition mbAddrCorrespond\mbPartIdxCorrespond of picture InterViewPic. Also, the following process is applied.
If predFlagLXCorrespond is equal to “1”, mvCorrespond and reference index refIdxCorrespond are set to MvLX[mbPartIdxCorrespond][subMbPartIdxCorrespond] and RefIdxLX[mbPartIdxCorrespond], respectively. Also, MvLX[mbPartIdxCorrespond][subMbPartIdxCorrespond] and RefIdxLX[mbPartIdxCorrespond] are motion vector mvLX and reference index refIdxLX that are allocated to (sub-)macroblock partition mbAddrCorrespond\mbPartIdxCorrespond\subMbPartIdxCorrespond within picture InterViewPic, respectively.

<1.1.6: Derivation Process about Luma Motion Vectors of VSP Skipped/Direct Macroblocks Included in B Slices>

An output of this process includes motion vectors mvL0 and mvL1, and reference indices refIdxL0 and refIdxL1.

A reference index refIdxLX of VSP skipped/direct macroblock is derived as a synthetic reference component that appears first in reference picture list X. Here, X is replaced with “0” or “1”. If the synthetic picture is absent in the reference picture list X, refIdxLX is set to 0. Motion vector mvLX is set to a zero motion vector. Here, X is replaced with “0” or “1”.

<1.1.7: Derivation Process about Luma Motion Vector Prediction>

An input of this process follows as.
macroblock partition index mbPartIdx,
sub-macroblock partition index subMbPartIdx,
reference index of current partition refIdxLX (here, X=0 or 1),
variable currSubMbType.

An output of this process includes prediction mvpLX of motion vector mvLX (here, X=0 or 1).

The following contents are applied to a subclause (J.8.4.1.3).

Under the condition that N=A, B, or C, and X=0 or 1, if refIdxLX is not equal to refIdxLXN, the following contents are applied.

mbAddrN\mbPartIdxN\subMbPartIdxN is marked to be unavailable.
refIdxLXN=−1
mvLXN[0]=0
mvLXN[1]=0

A derivation process about neighboring blocks of motion data is invoked. In this instance, mbPartIdx, subMbPartIdx, currSubMbType, and listSuffixFlag=X (here, X=0 or 1 for refIdxLX or refIdxL1 1) are set as an input. Also, mbAddrN\mbPartIdxN\subMbPartIdxN, reference indices refIdxLXN, and motion vectors mvLXN (here, N is replaced with A, B, or C) are allocated as an output.
The following additional contents are applied.
   Otherwise, when refIdxLX is a reference index of an inter-view reference component or an inter-view only reference component, a depth based derivation process about a median luma inter-view motion vector prediction is invoked. In this instance, mbAddrN\mbPartIdxN\subMbPartIdxN, mvLXN, refIdxLXN (here, N is replaced with A, B, or C), and refIdxLX are set as an input, and motion vector predictor mvpLX is allocated as an output.
   Otherwise, when refIdxLX is a reference index of an inter reference component or an inter only reference component, a depth based derivation process about a medina luma temporal motion vector prediction is invoked. In this instance, mbAddrN\mbPartIdxN\subMbPartIdxN, mvLXN, refIdxLXN (here, N is replaced with A, B, or C), and refIdxLX are set as an input, and motion vector predictor mvpLX is allocated as an output.
   Otherwise, if MbPartWidth(mb_type) is equal to “8”, MbPartHeight(mb_type) is equal to “16”, mbPartIdx is equal to “mvpLX=mvLXCto 1”, and refIdxLXC is equal to refIdxLX, motion vector predictor mvpLX is derived as follows.

mvpLX=mvLXC

<1.1.8: Depth Based Derivation Process about Median Luma Inter-View Motion Vector Prediction>

An input of this process follows as.
Neighboring partitions mbAddrN\mbPartIdxN\subMbPartIdxN (here, N is replaced with A, B, or C),
motion vectors mvLXN of neighboring partitions (here, N is replaced with A, B, or C),
reference indices refIdxLXN of neighboring partitions (here, N is replaced with A, B, or C),
reference indices refIdxLXN of current partitions.

An output of this process is motion vector predictor mvpLX.

If partition mbAddrN\mbPartIdxN\subMbPartIdxN is unavailable or if refIdxLXN is not equal to refIdxLX, mvLXN is derived in the following order.
1. An inverse macroblock scanning process is invoked. In this instance, CurrMbAddr is set as an input and (x1, y1) is allocated as an output.
2. An inverse macroblock partition scanning process is invoked. In this instance, mbPartIdx is set as an input and (dx1, dy1) is allocated as an output.
3. An inverse sub-macroblock partition scanning process is invoked. In this instance, mbPartIdx and subMbPartIdx are set as an input and (dx2, dy2) is allocated as an output.
4. A modification process of an inter-view motion vector in median luma motion vector prediction is invoked. In this instance, depthPic=DepthRefPicList0[refIdxL0], dbx1=x1+dx1+dx2, dby1=y1+dy1+dy2, and mv=mvL0 are set as an input. Also, motion vector mvLXN is allocated as an output.

Each of components of motion vector predictor mvpLX is determined based on median values of corresponding vector components of motion vectors mvLXA, mvLXB, and mvLXC, as follows.

mvpLX[0]=Median(mvLXA[0], mvLXB[0], mvLXC[0])

mvpLX[1]=Median(mvLXA[1], mvLXB[1], mvLXC[1])

<1.1.8.1: Modification Process about Inter-View Motion Vector in Median Luma Motion Vector Prediction>

An input of this process follows as.
depth reference view component depthPic,
location of top-left sample (dbx1, dby1) of a partition,
motion vector mv.

An output of this process is motion vector mv.

Here, refViewId is assumed as a view id value of depthPic.

The following process is sequentially applied.
1. numSamples is assumed as partWidth*partHeight.
2. Variable maxDepth may be determined based on the following Table 7.

TABLE 7

maxDepth = INT_MIN
for(j = 0; j < partHeight; j++)
for(i = 0; i < partWidth; i++)
if(depthPic[dbx1 + i, dby1 + j] > maxDepth) maxDepth =
depthPic[dbx1 + i, dby1 +j]

3. Variable mv may be determined based on the following Table 8.

TABLE 8

index = ViewIdTo3DVAcquisitionParamindex(view_id)
refindex = ViewIdTo3DVAcquisitionParamindex(refViewId)
mv[0] = Disparity(NdrInverse[maxDepth], ZNear[dps_id, index], ZFar[dps_id, index],
FocalLengthX[dps_id, index], AbsTX[index] − AbsTX[refindex])
mv[1] = 0

<1.1.9: Depth Based Derivation Process about Median Luma Temporal Motion Vector Prediction>

An input of this process follows as.
Neighboring partitions mbAddrN\mbPartIdxN\subMbPartIdxN (here, N is replaced with A, B, or C),
motion vectors mvLXN of neighboring partitions (here, N is replaced with A, B, or C),
reference indices refIdxLXN of neighboring partitions (here, N is replaced with A, B, or C),
reference index refIdxLX of a current partition.

An output of this process is motion vector predictor mvpLX.

If partition mbAddrN\mbPartIdxN\subMbPartIdxN is unavailable or if refIdxLXN is not equal to refIdxLX, mvLXN is derived in the following order.
1. An inverse macroblock scanning process is invoked. In this instance, CurrMbAddr is set as an input and (x1, y1) is allocated as an output.
2. An inverse macroblock partition scanning process is invoked. In this instance, mbPartIdx is set as an input and (dx1, dy1) is allocated as an output.
3. An inverse sub-macroblock partition scanning process is invoked. In this instance, mbPartIdx and subMbPartIdx are set as an input and (dx2, dy2) is allocated as an output.
4. A process specified in subclause 1.1.10 is invoked. In this instance, depthPic set to DepthCurrPic, dbx1 set to x1+dx1+dx2, dby1 set to y1+dy1+dy2, and listSuffixFlag are set as an input. Also, InterViewPic, offset vector dv, and variable InterViewAvailable are allocated as an output.
5. refIdxCorrespond and mvCorrespond are set as follows.
If InterViewAvailable is equal to Od, refIdxCorrespond is set to “−1” and all of mvCorrespond [0] and mvCorrespond [1] are set to “0”.
Otherwise, the following processes are sequentially applied.
   Variable luma4×4BlkIdx is derived as (4*mbPartIdx+subMbPartIdx).
   An inverse 4×4 luma block scanning process is invoked. In this instance, luma4×4BlkIdx is set as an input and (x, y) is allocated as an output. Also, (xCorrespond, yCorrespond) is set to (x+(dv[0]>>4), y+(dv [1]>>4)), and mbAddrCorrespond is set to ((CurrMbAddr/PicWidthInMbs)+(dv[1]>>6))*PicWidthInMbs+(CurrMbAddr % PicWidthInMbs)+(dv[0]>>6).
   mbTypeCorrespond is set to syntax element mb_type of a mcro block having an address of mbAddrCorrespond within picture InterViewPic. If mbTypeCorrespond is equal to P_{—}8×8, P_{—}8×8ref0, or B_{—}8×8, subMbTypeCorrespond is set to syntax element sub_mb_type of a macroblock having an address of mbAddrCorrespond within picture InterViewPic.
mbPartIdxCorrespond is set to a macroblock partition index of a corresponding partition and subMbPartIdxCorrespond is set to a sub-macroblock partition index of a corresponding sub-macroblock partition. A derivation process about the macroblock and sub-macroblock partition indices is invoked. In this instance, a luma location equal to (xCorrespond, yCorrespond), a macroblock type equal to mbTypeCorrespond, and list subMbTypeCorrespond of the sub-macroblock type when mbTypeCorrespond is equal to P_{—}8×8, P_{—}8×8ref0, or B_{—}8×8 are set as an input. Also, macroblock partition index mbPartIdxCorrespond and sub-macroblock partition index subMbPartIdxCorrespond are allocated as an output.
Motion vector mvCorrespond and reference index refIdxCorrespond are determined as follows.
When macroblock mbAddrCorrespond is encoded using an intra prediction mode, a component of mvCorrespond is set to “0” and a component of refIdxCorrespond is set to “−1”.
Otherwise (if macroblock mbAddrCorrespond is not encoded using an intra prediction mode), prediction utilization flags predFlagLXCorrespond is set equal to PredFlagLX[mbPartIdxCorrespond], a prediction utilization flag of macroblock partition mbAddrCorrespond\mbPartIdxCorrespond of picture InterViewPic. Also, the following processes are applied.
   If predFlagLXCorrespond is equal to “1”, mvCorrespond and reference index refIdxCorrespond are set to MvLX[mbPartIdxCorrespond][subMbPartIdxCorrespond] and RefIdxLX[mbPartIdxCorrespond], respectively. Here, MvLX[mbPartIdxCorrespond][subMbPartIdxCorrespond] and RefIdxLX[mbPartIdxCorrespond] are motion vector mvLX and reference index refIdxLX allocated to (sub-)macroblock partition mbAddrCorrespond\mbPartIdxCorrespond\subMbPartIdxCorrespond within picture InterViewPic, respectively.
6. Motion vectors mvLXN are derived according to the following Table 9.

TABLE 9

```
If refIdxCorrespond is equal to refIdxLX,
  mvLXN[0] = mvCorrespond[0]
  mvLXN[1] = mvCorrespond[1]
Otherwise,
  mvLXN[0] = 0
  mvLXN[1] = 0
```

Each component of motion vector predictor mvpLX is determined based on median values of corresponding vector components of motion vectors mvLXA, mvLXB, and mvLXC.
mvpLX[0]=Median(mvLXA[0], mvLXB[0], mvLXC[0])
mvpLX[1]=Median(mvLXA[1], mvLXB[1], mvLXC[1])

<1.1.10: Derivation process about inter-view reference and disparity vector>

An input of this process includes depth reference view component depthPic, a location of a top-left sample (dbx1, dby1) of a partition, and listSuffixFlag.

An output of this process includes picture InterViewPic, offset vector dv, and variable InterViewAvailable.

InterViewAvailable is set to “0”.

The following Table 10 is applied to derive an inter-view reference picture or an inter-view only reference picture, and InterViewPic. In this instance, when listFuffixFlag is “1” or “0” otherwise, X is set to “1”.

TABLE 10

```
for(cIdx = 0;cIdx<num_ref_idx_l0_active_minus1 + 1 && !InterViewAvailable; cIdx ++)
    if (view order index of RefPicList0[cIdx] is equal to 0) {
      InterViewPic = RefPicList0[cIdx]
      InterViewAvailable = 1
  }
```

If InterViewAvailable=1, the following operations are sequentially applied.
1) Variable maxDepth is designated as expressed by the following Table 11.

TABLE 11

```
  maxDepth = INT_MIN
  for(j = 0; j < partHeight; j+=(partHeight−1))
    for(i = 0; i < partWidth; i+=(partWidth−1))
      if(depthPic[dbx1 + i, dby1 + j] > maxDepth) maxDepth = depthPic[dbx1 + i, dby1 +
j]
```

2) Variable dv is designated as expressed by the following Table 12.

TABLE 12

```
index = ViewIdTo3DVAcquisitionParamindex(view_id of the
current view)
refindex = ViewIdTo3DVAcquisitionParamindex(view_id of the
InterViewPic)
  dv[0] = Disparity(NdrInverse[maxDepth], ZNear[dps_id, index],
  ZFar[dps_id, index],
    FocalLengthX[dps_id, index], AbsTX[index] − AbsTX[refindex])
dv[1] = 0
```

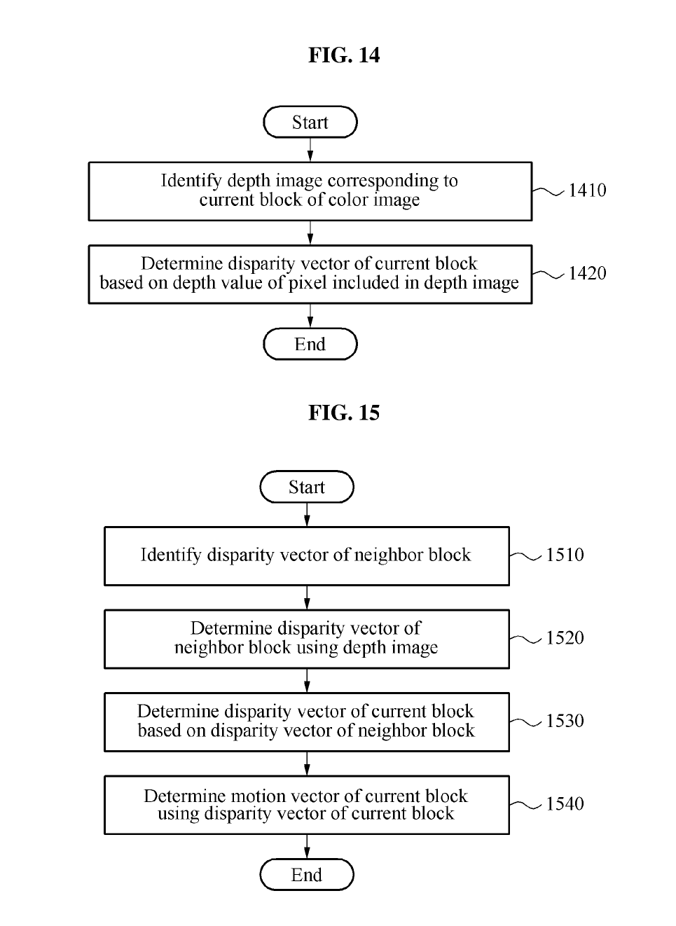

FIG. 14 is a flowchart illustrating an image processing method for predicting a disparity vector of a current block according to an example embodiment.

In operation 1410, an image processing apparatus may identify a depth image corresponding to a current block of a color image. When the depth image corresponding to the color image is absent, the image processing apparatus may estimate the depth image corresponding to the current block using a neighbor color image of the color image including the current block or another depth image.

In operation 1420, the image processing apparatus may determine a disparity vector of the current block based on a depth value of a pixel included in the depth image. The image processing apparatus may determine the disparity vector of the current block based on depth information of the depth image corresponding to the current block. The image processing apparatus may identify at least one pixel from among pixels included in the depth image, and may convert the largest depth value among depth values of the identified pixels to the disparity vector of the current block.

For example, the image processing apparatus may determine or estimate the disparity vector of the current block based on a depth value of a pixel included in a block of the depth image corresponding to the current block. The image processing apparatus may convert the largest depth value among depth values of one or more pixels included in the corresponding block of the depth image to the disparity vector. Alternatively, the image processing apparatus may identify a depth value of a pixel located in a predetermined area within the depth image, from among a plurality of pixels included in the corresponding block of the depth image. For example, the image processing apparatus may identify depth values of pixels located at corners of the corresponding block of the depth image, or may identify depth values of pixels located at corners of the corresponding block and a depth value of a pixel located at the center of the corresponding block. The image processing apparatus may convert the largest depth value among depth values of pixels located in the predetermined area to the disparity vector. The image processing apparatus may determine the converted disparity vector as the disparity vector of the current block.

In another example, the image processing apparatus may determine the disparity vector of the current block based on a macroblock including the corresponding block of the depth image. For example, the image processing apparatus may convert the largest depth value among depth values of pixels included in the macroblock to the disparity vector of the current block, or may convert the largest depth value among depth values of predetermined pixels included in the macroblock to the disparity vector of the current block. Also, in another example, the image processing apparatus may use only a predetermined pixel within the depth image corresponding to the current block. For example, the image processing apparatus may convert a depth value of a predetermined single pixel included in the depth image corresponding to the current block, to a disparity vector, and may determine the converted disparity vector as the disparity vector of the current block. Alternatively, the image processing apparatus may convert a depth value of a predetermined single pixel within the corresponding block or the macroblock to the disparity vector of the current block.

The image processing apparatus may use camera parameter information during a process of converting a depth value to a disparity vector.

FIG. 15 is a flowchart illustrating an image processing method for predicting a motion vector of a current block according to an example embodiment.

In operation 1510, the image processing apparatus may identify a disparity vector of a neighbor block adjacent to a current block of a color image, and may determine whether a disparity vector is present in the neighbor block.

In operation 1520, when the neighbor block does not have a disparity vector, the image processing apparatus may determine or estimate the disparity vector of the neighbor block using a depth image corresponding to the color image.

The image processing apparatus may identify at least one pixel from among pixels included in the depth image corresponding to the current block. The image processing apparatus may convert the largest depth value among depth values of identified pixels to a disparity vector, and may determine the converted disparity vector as the disparity vector of the neighbor block. The image processing apparatus may use only a portion of pixels included in the depth image, and may convert the largest depth value among depth values of the portion of pixels to the disparity vector of the neighbor block. For example, the image processing apparatus may convert, to a disparity vector, a depth value of a predetermined single pixel included in the depth image corresponding to the current block.

The image processing apparatus may convert the largest depth value among depth values of one or more pixels included in the corresponding block of the depth image corresponding to the current block, to a disparity vector, and may determine the converted disparity vector as the disparity vector of the neighbor block. Alternatively, the image processing apparatus may identify a depth value of a pixel located in a predetermined area from among a plurality of pixels included in the block of the depth image corresponding to the current block. For example, the image processing apparatus may identify depth values of pixels located at corners of the corresponding block. In another example, the image processing apparatus may identify depth values of pixels located at corners of the corresponding block and a depth value of a pixel located at the center of the corresponding block. The image processing apparatus may convert the largest depth value among depth values of pixels located in the predetermined area to the disparity vector. The image processing apparatus may determine the converted disparity vector as the disparity vector of the neighbor block.

In another example, the image processing apparatus may determine the disparity vector of the neighbor block based on a macroblock including the corresponding block of the depth image. For example, the image processing apparatus may convert the largest depth value among depth values of pixels included in the macroblock to the disparity vector of the neighbor block, or may convert the largest depth value among depth values of predetermined pixels included in the macroblock to the disparity vector of the neighbor block.

In operation 1530, the image processing apparatus may determine the disparity vector of the current block based on the disparity vector of the neighbor block. For example, the image processing apparatus may apply a median filter to the disparity vector of the neighbor block, and may determine a median filtered result as the disparity vector of the current block.

In operation 1540, the image processing apparatus may determine a motion vector of the current block using the disparity vector of the current block. The image processing apparatus may identify a location in a neighbor color image of the color image including the current block, using the disparity vector of the current block, and may determine the motion vector at the identified location as the motion vector of the current block.

The image processing apparatus may identify the location in the neighbor color image of the color image including the current block, using the determined disparity vector of the current block. The image processing apparatus may determine the motion vector at the identified location as the motion vector of the current block. When the motion vector is absent at the identified location, the image processing apparatus may determine the motion vector of the current block using the neighbor block adjacent to the current block. The image processing apparatus may determine the motion vector of the current block based on at least one of the motion vector and the disparity vector of the neighbor block.

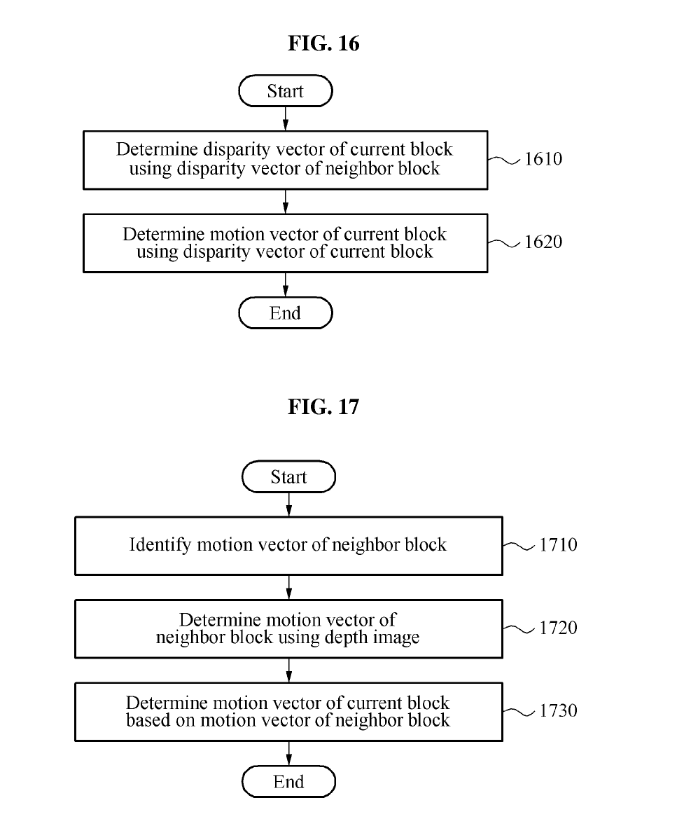

FIG. 16 is a flowchart illustrating an image processing method for predicting a motion vector of a current block according to another example embodiment.

In operation 1610, the image processing apparatus may determine a disparity vector of the current block using a disparity vector of a neighbor block adjacent to a current block of a color image. The image processing apparatus may determine whether a disparity vector is present in the neighbor block, and may determine the disparity vector of the neighbor block using a depth image corresponding to the color image when the neighbor block does not have a disparity vector.

When the neighbor block does not have the disparity vector, the image processing apparatus may identify the depth image corresponding to the current block of the color image. The image processing apparatus may determine the disparity vector of the neighbor block based on a depth value of at least one pixel included in the depth image.

For example, the image processing apparatus may convert the largest depth value among depth values of one or more pixels included in a block of the depth image corresponding to the current block or a macroblock, to a disparity vector, and may determine the converted disparity vector as the disparity vector of the neighbor block.

Alternatively, the image processing apparatus may use only a portion of pixels included in the corresponding block of the depth image or the macroblock, and may convert the largest depth value among depth values of the pixels to the disparity vector of the neighbor block. For example, the image processing apparatus may convert, to a disparity vector, the largest depth value among depth values of pixels located in a predetermined area of the corresponding block of the depth image corresponding to the current block or the macroblock, and may determine the converted disparity vector as the disparity vector of the neighbor block.

In addition, in another example, the image processing apparatus may use only a predetermined pixel within the depth image corresponding to the current block. For example, the image processing apparatus may convert, to a disparity vector, a depth value of a single pixel included in the depth image corresponding to the current block, and may determine the converted disparity vector as the disparity vector of the neighbor block.

The image processing apparatus may determine the disparity vector of the current block based on the disparity vector of the neighbor block. For example, the image processing apparatus may determine the disparity vector of the current block by applying a median filter to the disparity vector of the neighbor block, and using a result of the median filtered disparity vector as the disparity vector of the current block.

In operation 1620, the image processing apparatus may determine a motion vector of the current block using the disparity vector of the current block. The image processing apparatus may identify a location in a neighbor color image of the color image including the current block, using the disparity vector of the current block. The image processing apparatus may determine a motion vector at the identified location as the motion vector of the current block. When the motion vector is absent at the identified location, the image processing apparatus may determine the motion vector of the current block based on at least one of the motion vector and the disparity vector of the neighbor block adjacent to the current block. When the motion vector of the current block cannot be determined even using the motion vector or the disparity vector of the neighbor block, the image processing apparatus may determine a zero motion vector as the motion vector of the current block.

FIG. 17 is a flowchart illustrating an image processing method for predicting a motion vector of a current block according to still another example embodiment.

In operation 1710, the image processing apparatus may identify a motion vector of a neighbor block adjacent to a current block of a color image. For instance, the image processing apparatus may determine whether a motion vector is present in the neighbor block.

In operation 1720, when the neighbor block does not have a motion vector, the image processing apparatus may determine the motion vector of the neighbor block using a depth image corresponding to the color image.

To determine the motion vector of the neighbor block, the image processing apparatus may acquire a disparity vector using the depth image. For example, the image processing apparatus may identify at least one pixel included in the depth image corresponding to the current block, and may convert the largest depth value among depth values of identified pixels to a disparity vector. Alternatively, to determine the motion vector of the neighbor block, the image processing apparatus may use only a predetermined pixel within a depth image corresponding to a current color image.

The image processing apparatus may determine the motion vector of the neighbor block based on a macroblock including a corresponding block of the depth image. For example, the image processing apparatus may convert, to the disparity vector of the neighbor block, the largest depth value among depth values of predetermined pixels in the macroblock including the corresponding block, and may estimate the motion vector of the neighbor block using the converted disparity vector.

The image processing apparatus may identify a location indicated by the disparity vector based on the disparity vector. The image processing apparatus may determine the motion vector at the identified location as the motion vector of the neighbor block. When the motion vector is absent at the identified location, the image processing apparatus may determine a zero motion vector as the motion vector of the neighbor block.

In operation 1730, the image processing apparatus may determine the motion vector of the current block based on the motion vector of the neighbor block. For example, the image processing apparatus may determine the motion vector of the current block by applying a median filter to the motion vector of the neighbor block.

The above-described embodiments may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. The non-transitory computer-readable media may also be a distributed network, so that the program instructions are stored and executed in a distributed fashion. The program instructions may be executed by one or more processors. The non-transitory computer-readable media may also be embodied in at least one application specific integrated circuit (ASIC) or Field Programmable Gate Array (FPGA), which executes (processes like a processor) program instructions. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

Although example embodiments have been shown and described, it would be appreciated by those skilled in the art that changes may be made in these example embodiments without departing from the principles and spirit of the disclosure, the scope of which is defined by the claims and their equivalents.

1. An image processing method, comprising:
identifying a depth image corresponding to a current block of a color image; and
determining a disparity vector of the current block based on a depth value of at least one pixel comprised in the depth image.

2. The image processing method of claim 1, wherein the determining of the disparity vector of the current block comprises:
identifying the at least one pixel from among pixels comprised in the depth image corresponding to the current block; and
converting a largest depth value among depth values of the identified at least one pixels to the disparity vector of the current block, and determining a result of the converting as the disparity vector of the current block.

3. The image processing method of claim 1, wherein the determining of the disparity vector of the current block comprises:
identifying the at least one pixel from among pixels comprised in a block of the depth image, the block of the depth image corresponding to the current block; and
converting a largest depth value among depth values of the identified at least one pixels to the disparity vector of the current block, and determining a result of the converting as the disparity vector of the current block.

4. The image processing method of claim 1, wherein the determining of the disparity vector of the current block comprises:
identifying pixels located in a predetermined area within the depth image corresponding to the current block; and
converting a largest depth value among depth values of the identified pixels to the disparity vector of the current block, and determining a result of the converting as the disparity vector of the current block.

5. The image processing method of claim 4, wherein the identifying of the pixels located in the predetermined area comprises identifying pixels located at corners of the depth image within a macroblock of the depth image corresponding to the current block.

6. The image processing method of claim 4, wherein the identifying of the pixels located in the predetermined area comprises identifying pixels located at corners within a macroblock of the depth image corresponding to the current block and at the center of the corresponding block.

7. The image processing method of claim 1, wherein the determining of the disparity vector of the current block comprises:
identifying the at least one pixel from among pixels comprised in a macroblock of the depth image corresponding to the current block; and
converting a largest depth value among depth values of the identified at least one pixel to the disparity vector of the current block, and determining a result of the converting as the disparity vector of the current block,
wherein the macroblock is a depth image block comprising a block of the depth image corresponding to the current block.

8. The image processing method of claim 1, wherein the determining of the disparity vector of the current block comprises determining the disparity vector of the current block using a parameter of a camera used to capture the depth image.

9. An image processing method, comprising:
identifying whether a disparity vector of at least one neighbor block is absent, the at least one neighbor block being adjacent to a current block of a color image;
determining the disparity vector of the at least one neighbor block using a depth image corresponding to the color image when the at least one neighbor block does not have the disparity vector; and
determining a disparity vector of the current block based on the determined disparity vector of the at least one neighbor block.

10. The image processing method of claim 9, wherein the determining of the disparity vector of the at least one neighbor block comprises:
identifying at least one pixel comprised in the depth image corresponding to the current block; and
converting a largest depth value among depth values of the identified at least one pixels to the disparity vector of the at least one neighbor block, and determining a result of the converting as the disparity vector of the at least one neighbor block.

11-12. (canceled)

13. The image processing method of claim 9, wherein the determining of the disparity vector of the at least one neighbor block comprises:
identifying at least one pixel from among pixels comprised in a macroblock of the depth image corresponding to the current block; and
converting a largest depth value among depth values of the identified at least one pixels to the disparity vector of the at least one neighbor block, and determining a result of the converting as the disparity vector of the at least one neighbor block,
wherein the macroblock is a depth image block comprising a block of the depth image corresponding to the current block.

14. The image processing method of claim 9, wherein the determining of the disparity vector of the current block comprises determining the disparity vector of the current block by applying a median filter to the disparity vector of the at least one neighbor block.

15. The image processing method of claim 9, further comprising:
determining a motion vector of the current block using the determined disparity vector of the current block.

16. The image processing method of claim 15, wherein the determining of the motion vector of the current block comprises:
identifying a location in a neighbor color image of the color image comprising the current block using the determined disparity vector of the current block; and
determining a motion vector at the identified location as the motion vector of the current block.

17. The image processing method of claim 15, wherein the determining of the motion vector of the current block comprises:
identifying a location in a neighbor color image of the color image comprising the current block using the determined disparity vector of the current block; and
determining the motion vector of the current block based on at least one of a disparity vector and a motion vector of a neighbor block adjacent to the current block when the motion vector is absent at the identified location.

18. An image processing method, comprising:
determining a disparity vector of a current block of a color image using a disparity vector of at least one neighbor block adjacent to the current block of the color image; and
determining a motion vector of the current block using the determined disparity vector of the current block.

19. The image processing method of claim 18, wherein the determining of the disparity vector of the current block comprises determining the disparity vector of the current block by applying a median filter to the disparity vector of the at least one neighbor block.

20. The image processing method of claim 18, wherein the determining of the disparity vector of the current block comprises:
identifying at least one pixel from among pixels comprised in a depth image corresponding to the current block of the color image when the at least one neighbor block does not have a disparity vector;
determining the disparity vector of the at least one neighbor block based on a depth value of the identified at least one pixel; and
determining the disparity vector of the current block based on the determined disparity vector of the at least one neighbor block.

21. The image processing method of claim 20, wherein the determining of the disparity vector of the at least one neighbor block comprises converting, to the disparity vector of the at least one neighbor block, a largest depth value among depth values of one or more pixels comprised in a macroblock of the depth image corresponding to the current block, and determining a result of the converting as the disparity vector of the at least one neighbor block,
wherein the macroblock is a depth image block comprising a block of the depth image corresponding to the current block.

22. The image processing method of claim 20, wherein the determining of the disparity vector of the at least one neighbor block comprises:
identifying pixels located in a predetermined area within a macroblock of the depth image corresponding to the current block; and
converting a largest depth value among depth values of the identified pixels to the disparity vector of the at least one neighbor block, and determining a result of the converting as the disparity vector of the at least one neighbor block.

23. The image processing method of claim 18, wherein the determining of the motion vector of the current block comprises:
identifying a location in a neighbor color image of the color image comprising the current block using the determined disparity vector of the current block; and
determining a motion vector at the identified location as the motion vector of the current block.

24. The image processing method of claim 18, wherein the determining of the motion vector of the current block comprises:
identifying a location in a neighbor color image of the color image comprising the current block using the determined disparity vector of the current block; and
determining the motion vector of the current block based on at least one of a disparity vector and a motion vector of the at least one neighbor block adjacent to the current block when the motion vector is absent at the identified location.

25. An image processing method, comprising:
identifying whether a motion vector of at least one neighbor block adjacent to a current block of a color image is absent;
estimating the motion vector of the at least one neighbor block using a depth image corresponding to the color image when the motion vector is absent from the at least one neighbor block; and
determining a motion vector of the current block based on the motion vector of the at least one neighbor block.

26. The image processing method of claim 25, wherein the determining of the motion vector of the at least one neighbor block comprises:
identifying at least one pixel from among pixels comprised in the depth image, and converting a largest depth value among pixel values of the identified at least one pixels to a disparity vector;
identifying a location in a neighbor color image of the color image comprising the current block based on the converted largest depth value; and
determining a motion vector at the identified location as the motion vector of the at least one neighbor block.

27. The image processing method of claim 26, wherein the determining of the motion vector of the at least one neighbor block comprises determining a zero motion vector as the motion vector of the at least one neighbor block when the motion vector is absent at the identified location.

28. The image processing method of claim 25, wherein the determining of the motion vector of the at least one neighbor block comprises:
identifying at least one pixel from among pixels comprised in a macroblock of the depth image, and converting a largest depth value among depth values of the identified at least one pixels to the disparity vector;
identifying a location in a neighbor color image of the color image comprising the current block using a result of the converting; and
determining a motion vector at the identified location as the motion vector of the at least one neighbor block.

29. The image processing method of claim 25, wherein the determining of the motion vector of the current block comprises determining the motion vector of the current block by applying a median filter to the motion vector of the at least one neighbor block.

30. A non-transitory computer-readable media storing a program to implement the method according to claim 1.

31-51. (canceled)

52. The image processing method of claim 17, wherein the determining of the motion vector of the current block comprises:
when an index of a reference image indicates a color image of the same view, a median filter is applied to a motion vector of the neighbor block, and
the median filtered result is determined as the motion vector of the current block.

53. The image processing method of claim 17, wherein the determining of the motion vector of the current block comprises:
when an index of a reference image indicates a color image of a different view, a result of applying a median filter to the disparity vector of the current block is used as the motion vector of the current block.
